(19) United States
(12) Patent Application Publication
(10) Pub. No.: US 2025/0080672 A1
(43) Pub. Date: Mar. 6, 2025

(54) MANAGEMENT SYSTEM, METHOD, AND NON-TRANSITORY COMPUTER-READABLE STORAGE MEDIUM STORING PROGRAM

(71) Applicant: CANON KABUSHIKI KAISHA, Tokyo (JP)

(72) Inventor: HIROAKI KOIKE, Tokyo (JP)

(21) Appl. No.: 18/810,640

(22) Filed: Aug. 21, 2024

(30) Foreign Application Priority Data
Aug. 28, 2023 (JP) 2023-138203

(51) Int. Cl. H04N 1/00

(52) U.S. Cl. CPC H04N 1/00915; H04N 1/00342

(57) ABSTRACT

In a management system, a tag from which information can be read in a noncontact state is provided to be movable together with a product obtained by an apparatus corresponding to each process forming a workflow, and the system includes a detection unit that detects the tag arranged in association with the apparatus. The system includes: a specifying unit that specifies, based on a result of the detection of the tag by the detection unit, a job located in each process forming the workflow; and a display unit that displays information of the job specified by the specifying unit in association with each process forming the workflow.

### BACKGROUND OF THE INVENTION

### Field of the Invention

The present invention relates to a management system for managing processes of a workflow, a method, and a non-transitory computer-readable storage medium storing a program.

### Description of the Related Art

“Order placement/order reception” to “printing process” in commercial printing have been managed and visualized by print workflow software. In addition, the status of an online post-processing machine connected to a network has been managed and visualized by collecting information via the network. Japanese Patent Laid-Open No. 2021-149342 describes a technique of managing the progress of a job including one or more work processes based on image data obtained by capturing a slip conveyed together with the work target of the job.

The present invention provides a management system for improving convenience of management of a job in each process, a method, and a non-transitory computer-readable storage medium storing a program.

### SUMMARY OF THE INVENTION

The present invention in one aspect provides a method for a management system wherein a tag from which information can be read in a noncontact state is provided to be movable together with a product obtained by an apparatus corresponding to each process forming a workflow, the method comprising: detecting the tag arranged in association with the apparatus; specifying, based on a result of the detection of the tag, a job located in each process forming the workflow; and displaying information of the specified job in association with each process forming the workflow.

Further features of the present invention will become apparent from the following description of exemplary embodiments with reference to the attached drawings.

### BRIEF DESCRIPTION OF THE DRAWINGS

FIG. 1 is a block diagram showing the configuration of a manufacturing process management system;

FIG. 2 is a block diagram showing the hardware configuration of an information processing apparatus;

FIG. 3 is a block diagram showing the software configuration of the information processing apparatus;

FIG. 4 is a view showing a print job management screen;

FIG. 5 is a table showing a print job information table;

FIG. 6 is a table showing a merchandise information table;

FIG. 7 is a view showing the configuration of a position management system;

FIG. 8 is a block diagram showing the configuration of an RFID reader;

FIG. 9 is a block diagram showing the configuration of a user terminal;

FIG. 10 is a block diagram showing the configuration of a management server;

FIG. 11A to 11F are tables managed by the management server;

FIG. 12 is a view showing the configurations of a process management system and a production management system;

FIGS. 13A to 13C are tables managed by the process management system;

FIG. 14 is a view showing the arrangement of post-processes performed offline;

FIG. 15 is a table showing manufacturing process registration information;

FIG. 16 is a view showing a production management screen;

FIG. 17 is a flowchart illustrating processing of displaying a process management screen;

FIGS. 18A and 18B are tables managed in print job information data;

FIG. 19 is a view showing the process management screen;

FIG. 20 is a flowchart illustrating processing of generating a standby job list;

FIG. 21 is a view showing an example in which an error job area is provided;

FIG. 22 is a flowchart illustrating processing of displaying the process management screen;

FIGS. 23A and 23B are flowcharts illustrating processing of calculating the number of standby jobs and processing of generating a standby job list;

FIG. 24 is a view showing an example in which an area where a high urgency job is arranged is provided;

FIGS. 25A and 25B are flowcharts illustrating processing of calculating the number of standby jobs and processing of generating a standby job list;

FIGS. 26A and 26B are tables each showing a process position table; and

FIG. 27 is a view showing an example of the process management screen.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

With respect to a process performed by an offline post-processing machine, it is impossible to collect information via a network. Therefore, it is impossible to manage and visualize a status such as a length of time during which a job stands by in each process and a specific process where a specific job exists.

According to the present disclosure, convenience of management of a job in each process is improved.

### First Embodiment

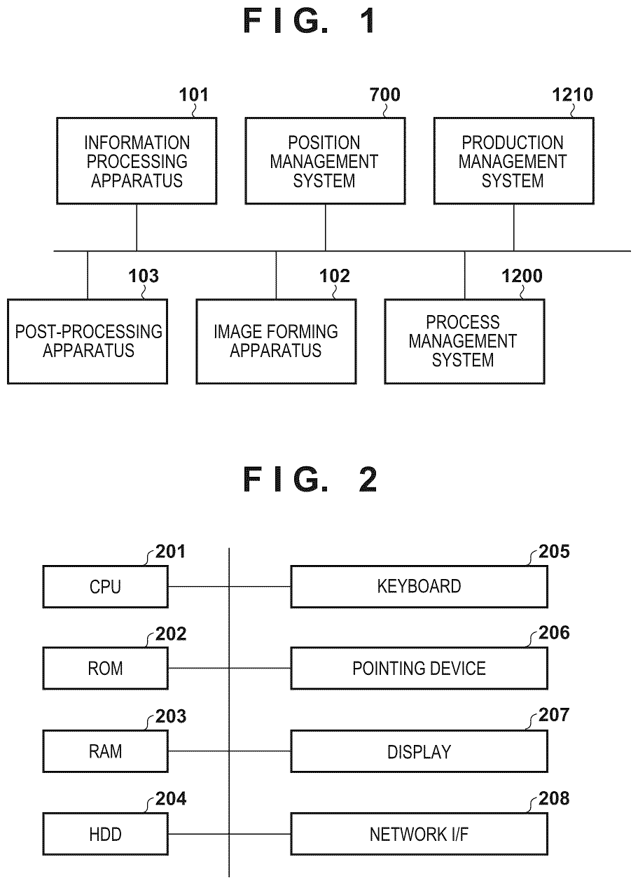

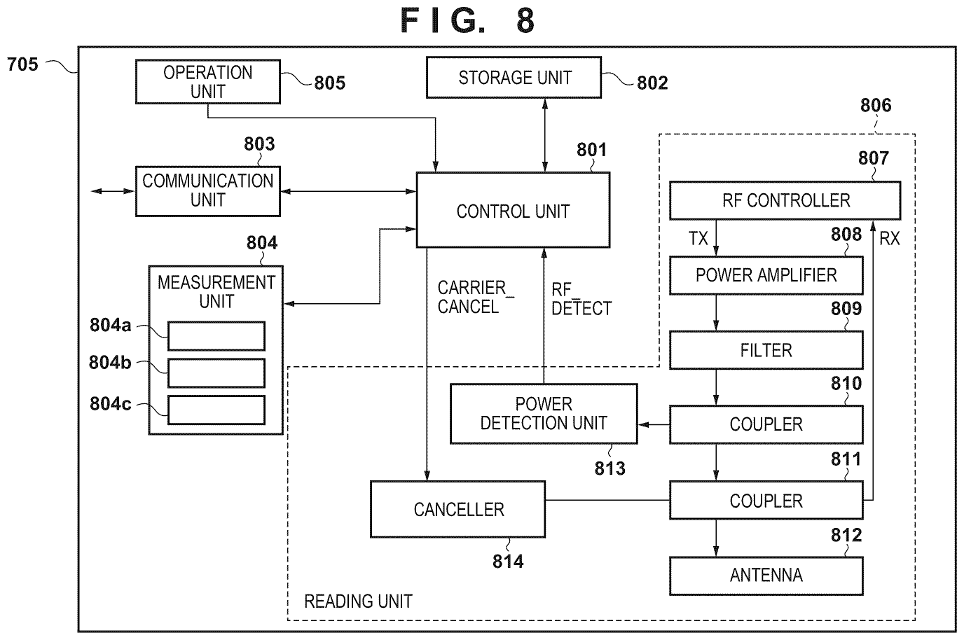

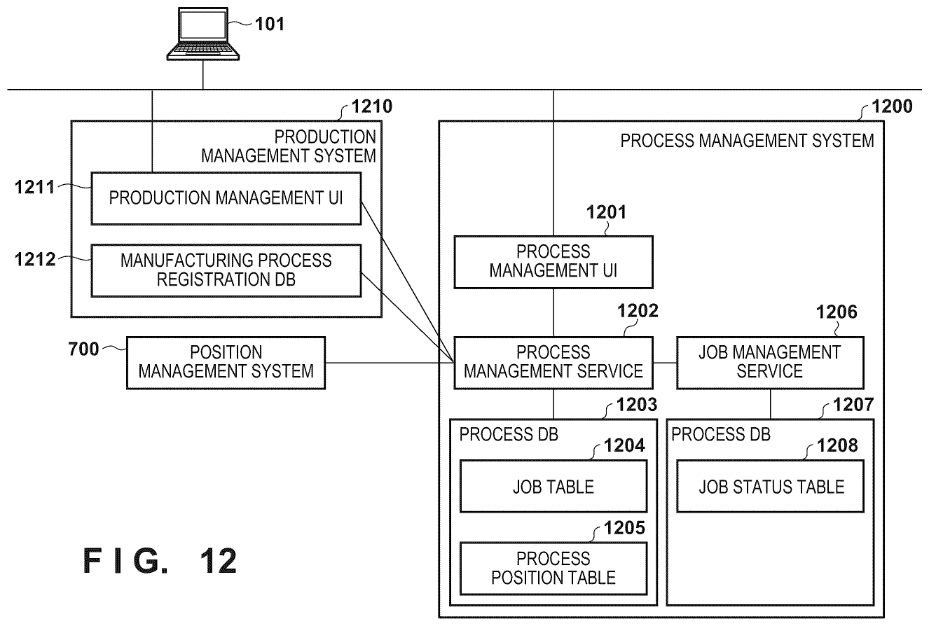

FIG. 1 is a block diagram showing an example of the configuration of a manufacturing process management system according to this embodiment. The management system according to this embodiment includes an information processing apparatus 101, an image forming apparatus 102, a post-processing apparatus 103, a position management system 700, a process management system 1200, and a production management system 1210. The information processing apparatus 101, the image forming apparatus 102, the position management system 700, the process management system 1200, and the production management system 1210 are connected via a network so as to be able to communicate. The position management system 700 will be described later with reference to FIG. 7. The process management system 1200 and the production management system 1210 will be described later with reference to FIG. 12. The image forming apparatus 102 analyzes print data transmitted from the information processing apparatus 101 or the like, and converts each page into a dot image, thereby executing printing. A printed material output from the image forming apparatus 102 is transferred to the post-processing apparatus 103 by the operator's hand carrying or transferred to the post-processing apparatus 103 via a belt conveyor (not shown). In this embodiment, the post-processing apparatus 103 is configured in an offline state in which it operates alone without communicating with the image forming apparatus 102 or the information processing apparatus 101. That is, the post-processing apparatus 103 is in a state in which it is not connected to the network. The post-processing apparatus 103 performs processes such as cutting, laminating, folding, and bookbinding for a printed material placed by the operator. Note that it is also possible to cut the materials having undergone bookbinding using a plurality of post-processing apparatuses. Note that in FIG. 1, one information processing apparatus 101, one image forming apparatus 102, and one post-processing apparatus 103 are illustrated, but the numbers of apparatuses may be plural. For example, the printed materials output from the plurality of image forming apparatuses may be processed by the plurality of post-processing apparatuses 103.

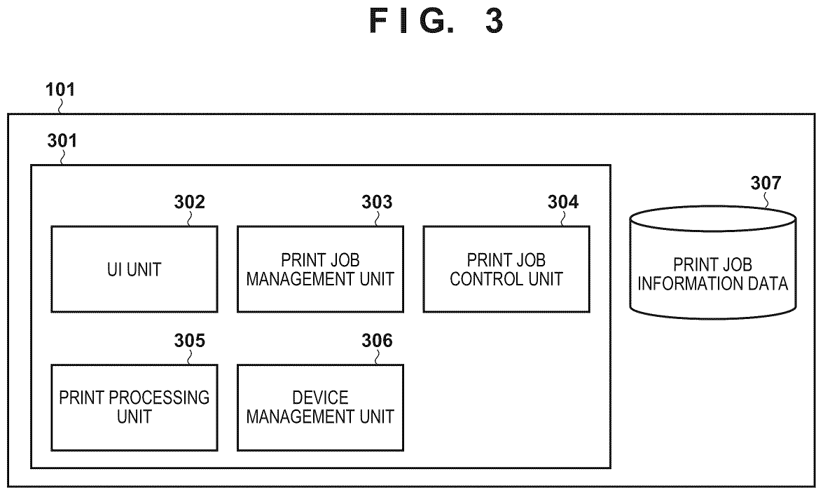

FIG. 2 is a block diagram showing an example of the hardware configuration of the information processing apparatus 101. A CPU 201 comprehensively executes various kinds of control processes by reading out control programs stored in a ROM 202 or an HDD 204. A RAM 203 is used as a temporary storage area such as the main memory or the work area of the CPU 201. The Hard Disk Drive (HDD) 204 stores image data and various programs. Note that another storage device such as a Solid State Drive (SSD) may be provided instead of or in addition to the HDD. A keyboard 205 is an input device serving as an instruction input unit, and instructs a control command instruction or text input to each application based on a user operation. Similar to the keyboard 205, a pointing device 206 is an input device serving as an instruction input unit, and instructs a control command instruction to each application based on a user operation. A display 207 is an output device serving as a display unit, and displays a command input from the keyboard 205 or the pointing device 206, the UI screen of each application, and the like. A network I/F 208 connects the information processing apparatus 101 to the network. The information processing apparatus 101 transmits/receives various kinds of information to/from another apparatus on the network via the network I/F 208. The network may be a wired network, a wireless network, or a network including both of them. For example, a LAN, an intranet, or the Internet may be used.

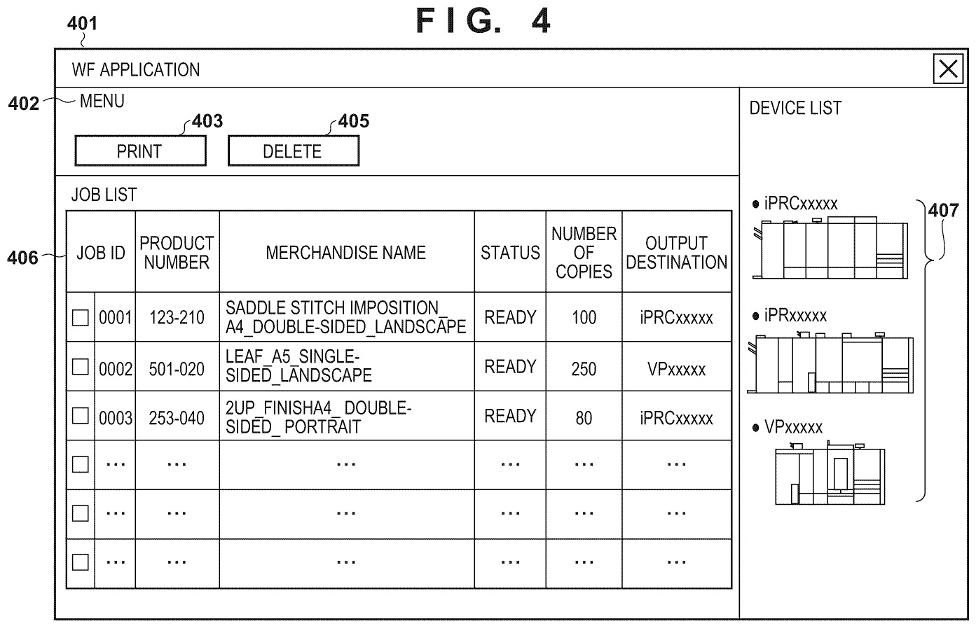

FIG. 3 is a block diagram showing an example of the software configuration of the information processing apparatus 101. A print workflow application 301 is a program module that is installed on the HDD 204 of the information processing apparatus 101 and, at the time of execution, loaded into the RAM 203 and executed by the CPU 201. The print workflow application 301 includes a UI unit 302, a print job management unit 303, a print job control unit 304, a print processing unit 305, and a device management unit 306.

The UI unit 302 generates a Graphical User Interface (GUI), and instructs execution of corresponding processing by accepting various input operations from the user. The print job management unit 303 accesses print job information data 307 (to be described later). This access is performed when, for example, the print workflow application 301 refers to various kinds of information of a print job to be transmitted to the image forming apparatus 102. The print job control unit 304 controls execution of various functions (transmission, editing, deletion, and the like of a print job) for the print job in the print workflow application 301.

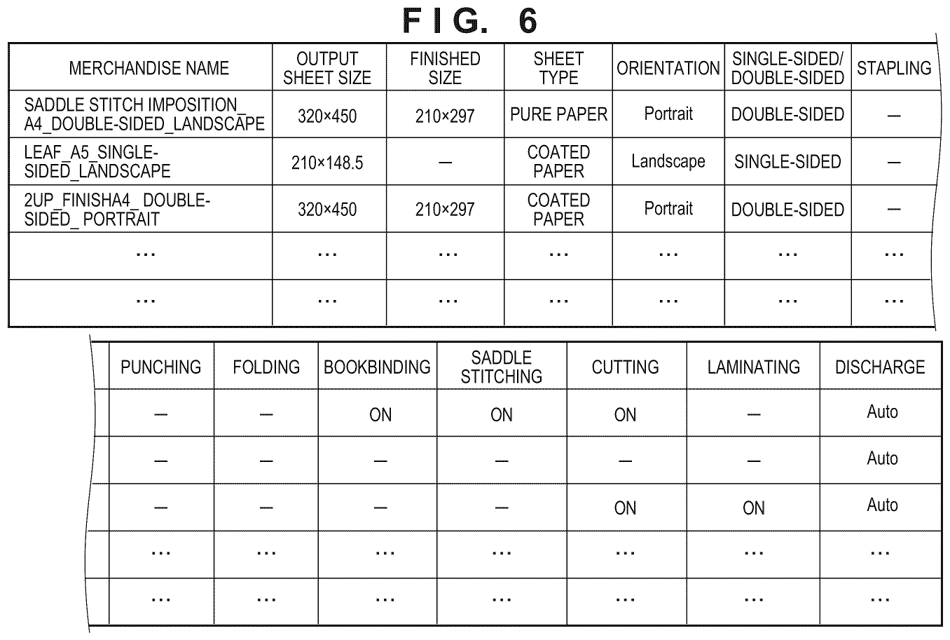

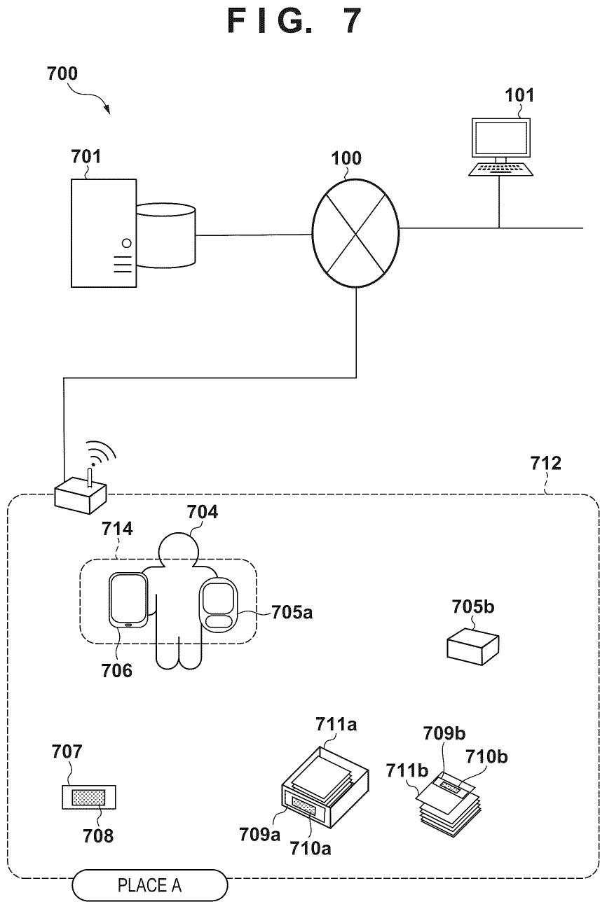

In response to a print job transmission instruction received from the print job control unit 304, the print processing unit 305 transmits content data and job ticket data of the print job to the image forming apparatus 102. The device management unit 306 manages various kinds of information (an identification name, an address, and the like) of the image forming apparatus 102 to which the print job is to be transmitted from the print workflow application 301. The print job information data 307 is a database that manages information (a print job information table and a merchandise information table) concerning the print job (to be described later). Note that the print job information table will be described later with reference to FIG. 5. The merchandise information table will be described later with reference to FIG. 6.

It has been described that the print workflow application 301 is installed on the HDD 204 of the information processing apparatus 101. However, the print workflow application 301 may be configured on a cloud, and may be provided as a cloud service by being accessed from the Web browser of the information processing apparatus 101. Furthermore, the print job information data 307 may be configured to store information not only in the HDD 204 of the information processing apparatus 101 but also in another information processing apparatus (a database server constructed as a server on the cloud or the like) connected by the network.

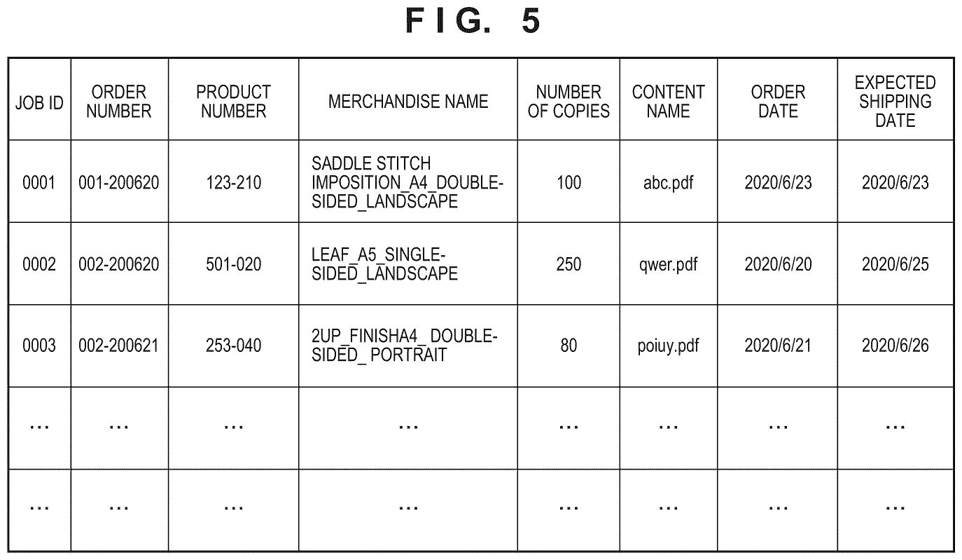

FIG. 4 is a view showing an example of a print job management screen of the print workflow application 301. When the operator instructs execution of the print workflow application 301 via the keyboard 205 or the pointing device 206 in the information processing apparatus 101, the CPU 201 loads a program into the RAM 203 and executes it. This activates the print workflow application 301. When the print workflow application 301 is activated, the UI unit 302 displays, on the display 207, the print job management screen shown in FIG. 4. The print workflow application 301 may display the print job management screen on the Web browser by accessing the cloud service from the Web browser of the information processing apparatus 101.

A print job management screen 401 indicates the print job management screen in the print workflow application 301. A function menu 402 indicates a menu of executable functions on the print job management screen 401. A print button 403 and a delete button 405 are arranged on the function menu 402. The print button 403 is a button for issuing a print instruction of a print job (an instruction of actual printing). The delete button 405 is a button for issuing a deletion instruction of a print job. Note that an editing button for issuing an editing instruction of a print job and the like may be provided on the function menu 402.

A print job list 406 indicates a list that displays a list of print jobs managed by the print workflow application 301. The print workflow application 301 accesses information of a print job stored in the print job information data 307 via the print job management unit 303, and displays it as a print job as a print target in the print job list 406.

A device list 407 displays a list of the image forming apparatuses 102 managed as output destinations by the print workflow application 301. The print workflow application 301 acquires, via the device management unit 306, information of the image forming apparatus 102 connected via the network so as to be able to communicate, and displays it in the device list 407. The operator selects, by the pointing device 206 or the like, the print job displayed in the print job list 406 and the image forming apparatus displayed in the device list 407, and presses the function button arranged on the function menu 402, thereby issuing a print instruction, a deletion instruction, an editing instruction, or the like with respect to the print job.

FIG. 5 is a table showing an example of the print job information table stored in the print job information data 307. In the example shown in FIG. 5, the print job information table includes items of a job ID, an order number, a product number, a merchandise name, the number of copies, a content name, an order date, and an expected shipping date. Note that the merchandise name is a value linked with information of detailed print settings (print attributes) defined in the merchandise information table shown in FIG. 6. Furthermore, the content name is link information to the file name of content data used at the time of printing the print job. Note that the expected shipping date may include time information.

FIG. 6 is a table showing an example of the merchandise information table stored in the print job information data 307. The merchandise information table defines the detailed setting values concerning printing (an output sheet size, a finished size, a sheet type, an orientation, single-sided/double-sided, stapling, punching, folding, bookbinding, cutting, a discharge destination, and the like). The print job information table shown in FIG. 5 and the merchandise information table shown in FIG. 6 are created in advance by a person in charge of installation such as an operator or an SE in accordance with the order contents of a printed material handled by the print workflow application 301. The print job management unit 303 acquires detailed print settings from the merchandise information table by using the above-described merchandise name as a key. For example, if the merchandise name is “saddle stitch imposition_A4_double-sided landscape”, settings of output sheet size “320×450”, sheet type “pure paper”, . . . , single-sided/double-sided “double-sided”, . . . , bookbinding “ON”, saddle stitch “ON”, cutting “ON”, laminating “ON”, . . . are acquired.

As shown in FIG. 6, for a job corresponding to each merchandise, setting values in post-processes executed by the post-processing apparatus 103 are set. However, as described above, since the post-processing apparatus 103 is installed offline, the print workflow application 301 cannot recognize, via the network, the specific post-processing apparatus 103 that executes the job. To cope with this, in this embodiment, the position of an article such as a returnable container capable of storing a product and the like is detected by a Radio Frequency Identification (RFID) tag from which information can be read in a noncontact state and which is added to the article by the position management system 700. With the detected position of the article, it is possible to manage which of the post-processing apparatuses 103 executes the job.

FIG. 7 is a view showing an example of the configuration of the position management system 700. The position management system 700 is a system that manages article data in a database. The position management system 700 includes a tag arranged in a place 712 under the management of the position management system 700, an RFID reader that detects the position of the tag, a mobile system 714, a network apparatus for connecting the RFID reader and the mobile system 714 to a network 100, and a management server 701. In this embodiment, the article data includes position information acquired by an RFID tag added to an article such as a returnable container. The network 100 shown in FIG. 7 corresponds to the network described with reference to FIG. 1.

The position management system 700 includes, for example, a position tag 707 installed in a place corresponding to each work process (each post-process) in a factory, article tags 709a and 709b each added to an article such as a returnable container, an RFID reader 705b arranged in the place corresponding to each work process in the factory, the mobile system 714 held by an operator 704, and the management server 701. The mobile system 714 includes an RFID reader 705a and a user terminal 706. As shown in FIG. 7, the position management system 700 can communicate with the information processing apparatus 101 via the network 100.

The mobile system 714, the RFID reader 705b, and the management server 701 are connected to the network 100. The network 100 may be a wired network, a wireless network, or an arbitrary combination of them. As the network 100, for example, the Internet, an intranet, and a cloud network are used.

The position tag 707 is a wireless device installed in each place where an article may be stored in the position management system 700, and includes unique tag identification information (to be referred to as a tag ID hereinafter) 708 embedded in the tag. Note that the place where an article may be stored is, for example, a place corresponding to each work process in the factory. The installation position of the position tag 707 may be fixed or may be changeable in each place.

Each of the article tags 709a and 709b is a wireless device added to each of articles to be managed in the position management system 700, and includes unique tag identification information (to be referred to as a tag ID hereinafter) 710a or 710b embedded in the tag. Note that the articles to be managed in the position management system 700 are, for example, a work instruction document transferred to the operator, and a returnable container that stores a product in each work process and moves between the work processes.

To manage which of the post-processing apparatuses 103 executes the job, it is necessary to link the job with the tag. In this embodiment, as an example of a configuration for linking a job with an article tag, an example of adding the article tag 709a to a returnable container 711a that stores a job when moving between the work processes, and an example of adding the article tag 709b to a work instruction document 711b for issuing a work instruction document. The work instruction document 711b is an instruction for the operator, in which the next process is described. In the work instruction document 711b, for example, a barcode indicating job information may be printed. This embodiment assumes an example in which the work instruction document 711b is put in the returnable container together with the product but the present invention is not limited to this. For example, the information of the work instruction document 711b may be displayed on the user terminal 706 of the mobile system 714. When the article added with the article tag such as the returnable container 711a or the work instruction document 711b is carried by the operator wearing the RFID reader 705a, the article tag 709a or 709b also moves together with the article. In the following description, if the article tags 709a and 709b need not particularly be discriminated, they will collectively be referred to as article tags 709 hereinafter by eliminating the alphabets at the ends of reference numerals. The same applies to the RFID readers 705 (705a and 705b), the tag IDs 710 (710a and 710b), the articles 711 (711a and 711b), and other elements to be described later.

This embodiment assumes that each of the tags such as the position tag 707 and the article tag 709 is a passive RFID tag (passive tag). The passive tag is formed by a small Integrated Circuit (IC) chip incorporating a memory, and an antenna, and stores identification information for identifying the tag and other information in the memory. In this embodiment, the identification information will simply be referred to as an ID hereinafter, and the identification information for identifying the tag will also referred to a tag ID hereinafter. In other words, the tag ID is information for identifying a target added with a tag. The IC chip of the passive tag operates using electromagnetic wave energy emitted from the RFID reader, modulates the tag ID and other information stored in the memory into an information signal, and transmits the modulated information signal from the antenna.

Note that each tag may be active RFID tag. When actively (for example, periodically) transmitting information to the surroundings using power from a battery incorporated in each tag, the tag is called a beacon tag. Alternatively, each tag may be a wireless device that transmits information by a Near Field Communication (NFC) method or a Bluetooth® method in response to a signal from the RFID reader. Each tag will sometimes be referred to as an IC tag, an IC card, a responder, or the like hereinafter.

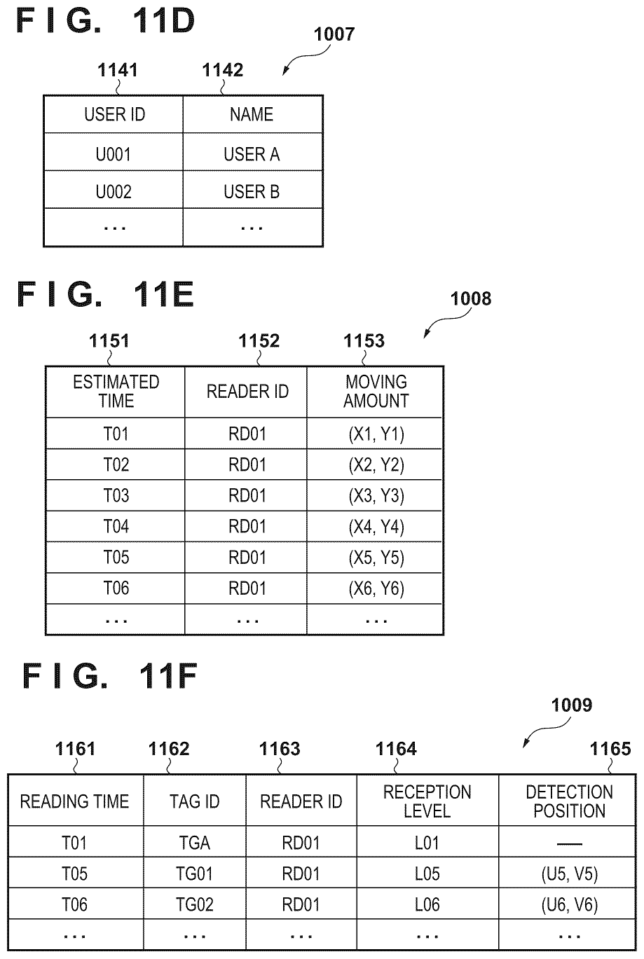

The RFID reader 705 is a reading apparatus that can read information stored in a wireless device such as an RFID tag. For example, the RFID reader 705 can detect the article 711 by reading the tag ID 710 from the article tag 709 added to the article 711. The RFID reader 705 executes reading in response to a trigger such as a user operation or periodically (at a predetermined time interval), and transmits a tag reading result to the management server 701. For example, reading result data indicated in each record in FIG. 11F is transmitted as a tag reading result. The RFID reader 705 may be directly able to communicate with the management server 701 or may be indirectly able to communicate with the management server 701 via a relay apparatus (for example, the user terminal 706).

The user terminal 706 of the mobile system 714 may be, for example, an arbitrary type of terminal apparatus or information processing apparatus, such as a notebook PC, a tablet PC, a smartphone, or a smartwatch. The user terminal 706 can be used for, for example, interaction with the operator 704 by the position management system 700. The management server 701 is an information processing apparatus for managing, in a database, a status concerning inspection of the location of each of the plurality of articles 711, position information, and other information. For example, the management server 701 is configured as an application server, a database server, or a cloud server using a high-performance general-purpose computer. The management server 701 receives the tag reading result from the RFID reader 705, and updates the database based on the received tag reading result.

The management server 701 may be formed by a single apparatus or formed by a plurality of physically separated apparatuses in cooperation with each other. This embodiment will describe an example in which the management server 701 holds the databases but an apparatus separated from the management server 701 may hold some or all of the databases. For example, the wireless device (for example, the position tag or the article tag), the RFID reader 705, or the user terminal 706 may hold some data.

Note that FIG. 7 shows an example in which the RFID reader 705a and the user terminal 706 are separated apparatuses. However, the mobile system 714 is not limited to this configuration. For example, the RFID reader 705a may have some or all of the functions of the user terminal 706, or the user terminal 706 may have some or all of the functions of the RFID reader 705a. In addition, the functions of the management server 701 may be implemented by the user terminal 706.

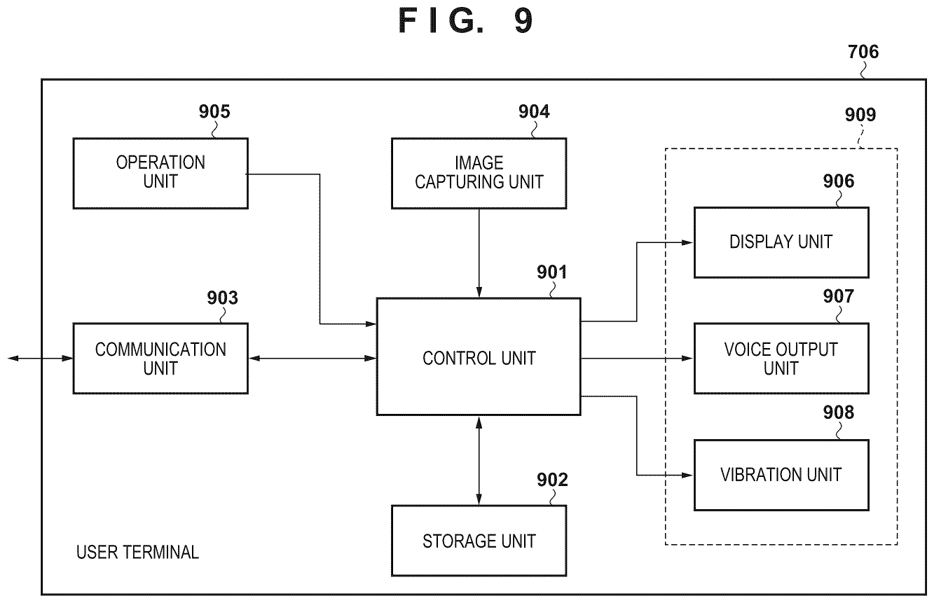

FIG. 8 is a block diagram showing an example of the configuration of the RFID reader 705. The RFID reader 705 includes a control unit 801, a storage unit 802, a communication unit 803, a measurement unit 804, an operation unit 805, and a reading unit 806. The control unit 801 includes a memory that stores computer programs, and one or more processors (for example, CPUs) that execute the computer programs. The control unit 801 comprehensively controls all the functions of the RFID reader 705. For example, the control unit 801 causes the reading unit 806 to read an RFID tag within a tag reading range, and causes the storage unit 802 to temporarily store the read information, a reading time, and the reception level of a signal as reading result data. Furthermore, simultaneously with reading of the RFID tag, the control unit 801 causes the measurement unit 804 to measure the position of the RFID reader 705, and causes the storage unit 802 to store the measurement result. After that, the control unit 801 transmits, to the management server 701 via the communication unit 803, the reading result data indicated in each record in FIG. 11F and measurement result data indicated in each record in FIG. 11E, which are stored in the storage unit 802 together with the RFID reader identification information (to be also referred to as an RFID reader ID hereinafter) of the self-apparatus.

The storage unit 802 may include, for example, any kind of storage medium like a semiconductor memory such as a ROM or a RAM, an optical disk, or a magnetic disk. In this embodiment, the storage unit 802 stores the above-described reading result data, the measurement result data, and the RFID reader ID of the RFID reader 705.

The communication unit 803 is a communication interface used by the RFID reader 705 to communicate with the management server 701. For example, the communication unit 803 may be a WLAN interface for communication with a Wireless Local Area Network (WLAN) access point or a cellular communication interface for communication with a cellular base station. Alternatively, the communication unit 803 may be a connection interface (for example, a Bluetooth® interface or a Universal Serial Bus (USB) interface) for connection to a relay apparatus.

The measurement unit 804 is a unit that can measure the position of the RFID reader 705. In this embodiment, the measurement unit 804 measures the relative moving amount of the RFID reader 705 from a given reference position using a self-position estimation technique also called Pedestrian Dead Reckoning (PDR), and outputs the measured moving amount to the control unit 801. The reference position for measurement of the relative moving amount may be, for example, the position of the RFID reader 705 when the RFID reader 705 is activated or the position of the position tag 707. The relative moving amount of the RFID reader 705 can be handled as a relative position. For example, the measurement unit 804 includes a three-axis acceleration sensor 804a, a gyro sensor 804b, and a geomagnetic sensor 804c. The three-axis acceleration sensor 804a measures acceleration applied to the RFID reader 705 in a device coordinate system unique to the RFID reader 705, and outputs first sensor data. The gyro sensor 804b measures the angular velocity of the RFID reader 705, that is, a change in posture of the RFID reader 705, and outputs second sensor data. The geomagnetic sensor 804c measures the direction of the RFID reader 705 in a real space, and outputs third sensor data. The measurement unit 804 can measure the relative moving amount of the RFID reader 705 by accumulating the acceleration of the RFID reader 705 while converting the direction of the acceleration of the RFID reader 705 into a direction in the coordinate system of the real space based on the first to third sensor data. The relative moving amount output from the measurement unit 804 to the control unit 801 may be a two-dimensional vector within a horizontal plane, or a three-dimensional vector also including a component in the height direction.

In this embodiment, the position coordinates of the installation position of each position tag 707 are already known and registered in the database. Therefore, the RFID reader 705a held by the operator 704 can estimate the current absolute position (position coordinates) of the RFID reader 705a based on the relative moving amount from when the given position tag 707 is detected until now and the known position coordinates of the position tag 707. In other words, the estimated position of the RFID reader 705a can be the position of the operator 704 or the position of the article tag 709 held by the operator 704 or close to the operator 704. This embodiment will describe an example in which the measurement unit 804 estimates the absolute position of the RFID reader 705. However, the absolute position of the RFID reader 705 may be acquired when the control unit 801 or the measurement unit 804 of the RFID reader 705 accesses an external database. The measurement unit 804 may measure the current geographic position of the RFID reader 705 using the Global Positioning System (GPS). Furthermore, the measurement unit 804 may perform base station positioning or wireless LAN positioning for estimating the current position using the known position coordinates of the base station or wireless LAN access point as a connection destination. Note that instead of providing the measurement unit 804 in the RFID reader 705, the mobile system 714 may include a measurement apparatus separated from the RFID reader 705 and capable of, for example, measuring the relative moving amount using the self-position estimation technique.

The operation unit 805 accepts a user operation by the operator 704. The operation unit 805 includes, for example, a physical input device such as a button, a switch, or a lever provided in the housing of the RFID reader 705. The operation unit 805 accepts an operation by the operator 704 via the input device, and outputs an operation signal to the control unit 801. In addition, the operation unit 805 may include a voice input interface such as a microphone.

The reading unit 806 is a unit capable of reading, from each of the position tag 707 and the article tag 709 under the management of the position management system 700, information stored in the tag. The reading unit 806 includes an RF controller 807, a power amplifier 808, a filter 809, a first coupler 810, a second coupler 811, an antenna 812, a power detection unit 813, and a canceller 814. The RF controller 807 outputs a transmission signal, for example, a signal modulated in the UHF band from a TX terminal to the power amplifier 808 under the control of the control unit 801. The power amplifier 808 amplifies the transmission signal input from the RF controller 807, and outputs it to the filter 809. The amplification factor of the transmission signal can variably be controlled. As the amplification factor is higher, the output intensity of an electromagnetic wave emitted from the RFID reader 705 is increased. The filter 809 may be, for example, a low-pass filter, and removes an unnecessary component of the transmission signal amplified by the power amplifier 808. The first coupler 810 distributes the transmission signal having passed through the filter 809 to the coupler 811 and the power detection unit 813. The second coupler 811 outputs, to the antenna 812, the transmission signal input from the first coupler 810, and outputs, to the RF controller 807, a reception signal input from the antenna 812. The antenna 812 transmits, as an electromagnetic wave, in air, the transmission signal input from the second coupler 811. The antenna 812 receives a signal transmitted, as a response to the transmission signal, from an RFID tag existing within the reading range of the RFID reader 705, and outputs the reception signal to the second coupler 811. As an example, the antenna 812 may be an omnidirectional antenna. As another example, the antenna 812 may be a directional antenna that can variably control the beam direction. The power detection unit 813 detects the power level of a signal input from the first coupler 810, and outputs a signal RF_DETECT indicating the detected power level to the control unit 801. The canceller 814 accepts a signal CARRIER_CANCEL indicating the power level of a carrier wave from the control unit 801. Then, the canceller 814 extracts a desired signal component of the reception signal to be output to the RX terminal of the RF controller 807 by canceling the carrier wave component of the transmission signal based on the signal CARRIER_CANCEL. The RF controller 807 demodulates the signal input from the RX terminal to acquire the transmitted tag ID and other information from the RFID tag, and outputs the acquired information to the control unit 801. Furthermore, the RF controller 807 measures the reception level (reception intensity) of the signal input from the RX terminal, and outputs the measurement result to the control unit 801.

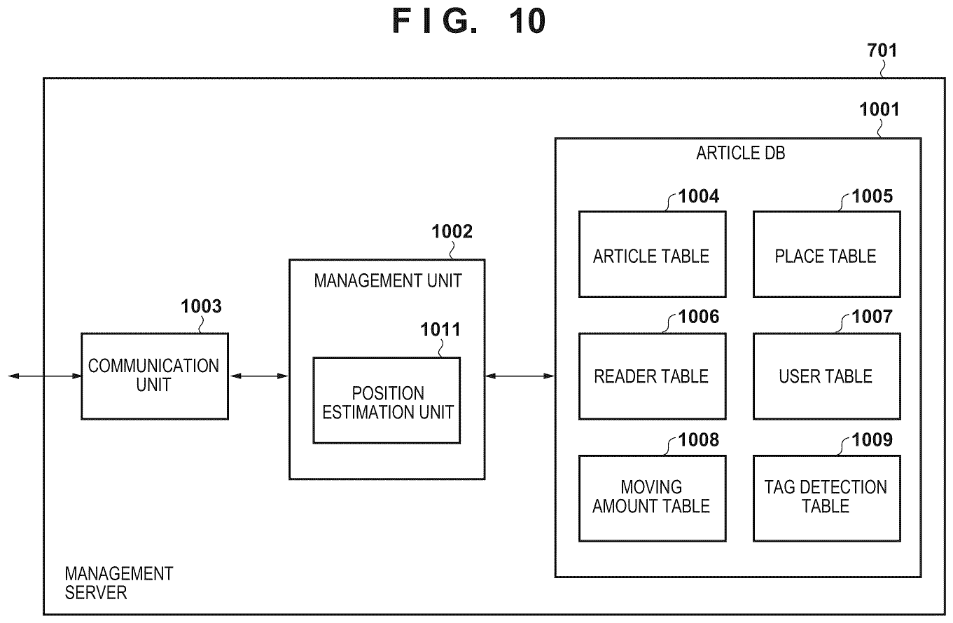

FIG. 9 is a block diagram showing an example of the configuration of the user terminal 706 included in the mobile system 714. The user terminal 706 includes a control unit 901, a storage unit 902, a communication unit 903, an image capturing unit 904, an operation unit 905, a display unit 906, a voice output unit 907, and a vibration unit 908.

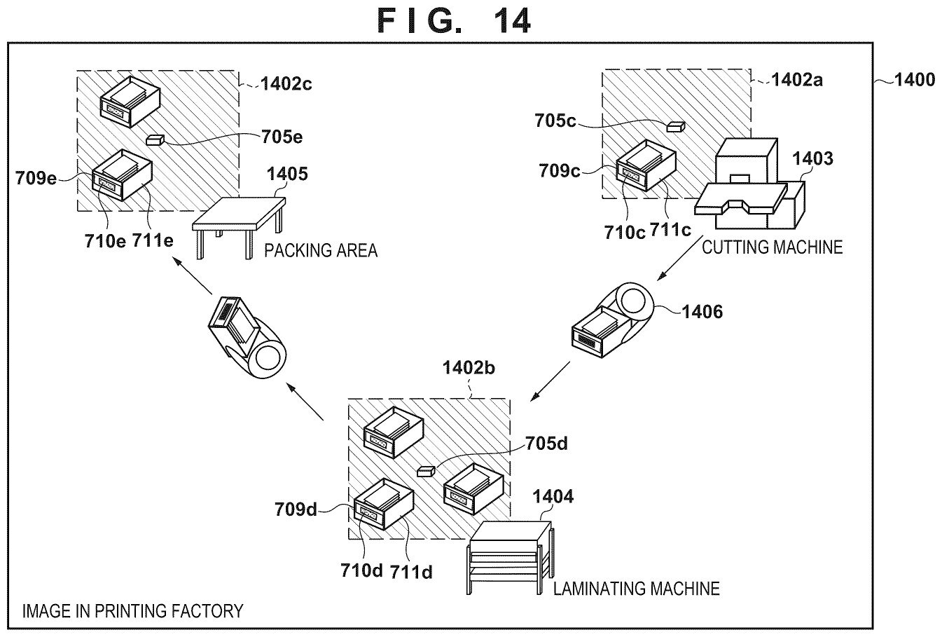

The control unit 901 includes a memory that stores computer programs, and one or more processors that execute the computer programs. The processor may be a CPU or an Integrated Circuit (IC) such as a microcontroller (for example, a one-chip microcomputer). The control unit 901 may include a timer circuit or a software timer for measuring the time. The control unit 901 comprehensively controls all the functions of the user terminal 706. For example, the control unit 901 displays, on the display unit 906, a screen for displaying the current position of the mobile system 714 and the position of an article existing on the periphery when inspecting the location of the article 711 in the position management system 700. When the location of the inspection target article is shown on the screen, it is possible to lead the operator 704 to the position of the target article. As a screen for leading the operator 704 to the position of the target article, for example, a simple map in the factory is displayed, as shown in FIG. 14. This screen may be displayed based on information of a work instruction document.

The storage unit 902 may include, for example, any kind of storage medium like a semiconductor memory such as a ROM or a RAM, an optical disk, or a magnetic disk. For example, the storage unit 902 temporarily stores map image data received from the management server 701 and the position information of the RFID reader 705a and the article 711 for screen display.

The communication unit 903 is a communication interface used by the user terminal 706 to communicate with the management server 701. For example, the communication unit 903 may be a WLAN interface or a cellular communication interface. Although not shown in FIG. 9, the user terminal 706 may further include a connection interface (for example, a Bluetooth® interface or a USB interface) for connection to a peripheral apparatus.

The image capturing unit 904 is a so-called camera unit that generates image data of a still image or a moving image by capturing a state in the real space. The image capturing unit 904 outputs the generated image data to the control unit 901. For example, the image data generated by the image capturing unit 904 is used for optical character recognition or for reading of a visible code such as a barcode or a QR Code®. For example, the image capturing unit 904 reads code information added to a returnable container, a work instruction document, or a region other than a print region on a printed sheet. The code information is, for example, a two-dimensional barcode including information of a job ID.

The operation unit 905 accepts an operation and information input by the operator 704. The operation unit 905 includes, for example, an input device such as a touch sensor, a keypad, a keyboard, a button, or a pointing device. The operation unit 905 accepts an operation by the operator 704 via the input device, and outputs an operation signal to the control unit 901. Furthermore, the operation unit 905 may further include another kind of input device like a voice input interface such as a microphone or a sensor that detects a vibration.

The display unit 906 displays an image and information. The display unit 906 may be, for example, a Liquid Crystal Display (LCD) or an Organic Light-Emitting Diode (OLED). The voice output unit 907 outputs a voice. The voice output unit 907 may be, for example, a loudspeaker. The vibration unit 908 vibrates the user terminal 706. The vibration unit 908 may be, for example, a vibrator including an eccentric motor. One or more of the display unit 906, the voice output unit 907, and the vibration unit 908 can function as a notification unit 909 that performs a notification to the operator 704. Note that although not shown in FIG. 9, a notification function similar to the notification unit 909 may be provided in the RFID reader 705.

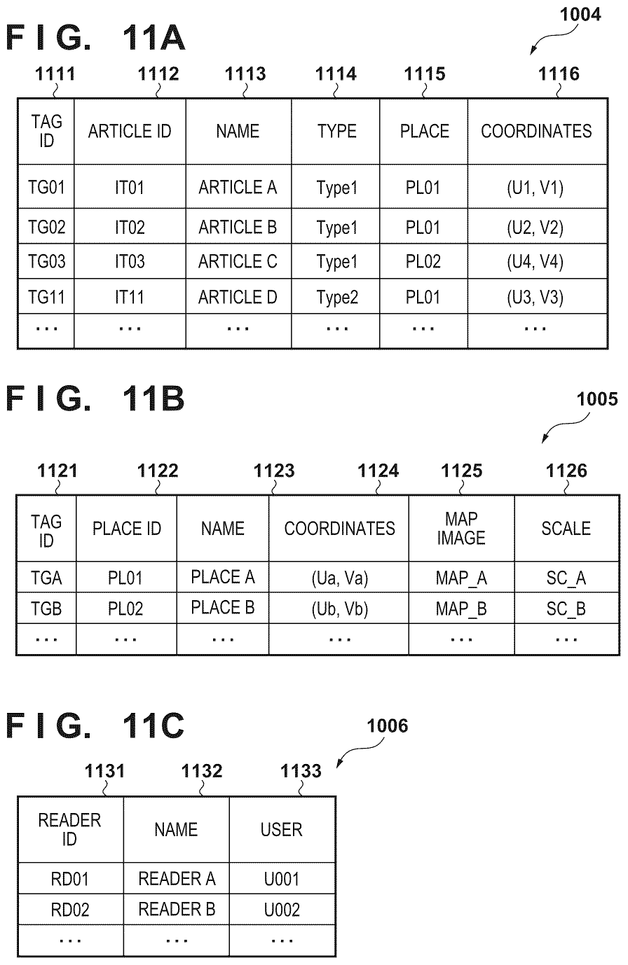

FIG. 10 is a block diagram showing an example of the configuration of the management server 701. The management server 701 includes a communication unit 1003, an article database (DB) 1001, and a management unit 1002. The communication unit 1003 is a communication interface used by the management server 701 to communicate with another apparatus. The communication unit 1003 may be a wired communication interface or a wireless communication interface. In this embodiment, the communication unit 1003 communicates with one or both of the RFID reader 705a and the user terminal 706 included in the mobile system 714. The article DB 1001 is a database that stores a status concerning inspection of the location of each of a plurality of articles under the management of the position management system 700, position information, and other information. In this embodiment, the article DB 1001 includes an article table 1004, a place table 1005, a reader table 1006, a user table 1007, a moving amount table 1008, and a tag detection table 1009. The management unit 1002 is a set of a plurality of software modules that provides a management function of managing data in the article DB 1001. Each software module can operate when one or more processors of the management server 701 execute the computer programs stored in the memory. In this embodiment, the management unit 1002 includes a position estimation unit 1011.

FIGS. 11A to 11F are tables showing examples of the structures of the article table 1004, the place table 1005, the reader table 1006, the user table 1007, the moving amount table 1008, and the tag detection table 1009 managed in the article DB 1001 of the management server 701 of the position management system 700.

The article table 1004 includes data items of a tag ID 1111, an article ID 1112, a name 1113, a type 1114, a place 1115, and coordinates 1116. The tag ID 1111 is identification information for uniquely identifying the article tag 709 added to each of the articles 711 under the management of the position management system 700. The value of the tag ID 1111 is equal to the value of the tag ID stored in the corresponding article tag 709. The article ID 1112 is identification information for uniquely identifying each article 711. The name 1113 represents the name of each article 711. The type 1114 represents a type into which each article 711 is classified. The values of the name 1113 and the type 1114 of each article 711 may be decided by the user, and registered in advance via a user interface screen provided by the management unit 1002. Alternatively, the values of the name 1113 and the type 1114 may be stored as article-related information in the article tag 709, and read by the RFID reader 705. In the latter case, based on the first tag reading from the article tag 709 of each article 711, the management server 701 can receive the values of the name 1113 and the type 1114 of the article 711 from the RFID reader 705, and register them in the article table 1004. The place 1115 represents a place, where each article 711 is lastly detected by the RFID reader 705, by a place ID for identifying the place. The place 1115 corresponds to a place corresponding to the position tag 707 existing near a position at which the article 711 is read. The coordinates 1116 represent the position coordinates of a point at which each article 711 is estimated to be located. In this embodiment, the coordinates of the position tag 707 existing near a position at which the article 711 is read are used as the coordinates 1116. When the RFID reader 705 detects the movement of the article, the position estimation unit 1011 can update the values of the place 1115 and the coordinates 1116. For example, when the RFID reader 705b in the next process place detects the article 711, the values of the coordinates 1116 are updated by the coordinates of the position tag 707 in the place.

The place table 1005 includes data items of a tag ID 1121, a place ID 1122, a name 1123, coordinates 1124, a map image 1125, and a scale 1126. The tag ID 1121 is identification information for uniquely identifying the position tag 707 installed in each of the places 712 under the management of the position management system 700. The value of the tag ID 1121 is equal to the value of the tag ID stored in the corresponding position tag 707. The place ID 1122 is identification information for uniquely identifying each place 712. Each place corresponds to, for example, the place of each work process. The name 1123 represents the name of each place 712. The coordinates 1124 represent the coordinates of the installation position of the position tag 707 installed in each place 712. The map image 1125 is a data item storing the map image data of each place 712. The scale 1126 represents a ratio for converting a distance on the map of the map image 1125 into a distance in the real space. The ratio is, for example, a value indicating how many meters in the real space are equivalent to one pixel of the image. Note that the map image data stored in the map image 1125 may be acquired from an external data source or uploaded and updated by the user at a necessary timing.

The RFID reader table 1006 includes data items of an RFID reader ID 1131, a name 1132, and a user 1133. The RFID reader ID 1131 is identification information for uniquely identifying each of the RFID readers 705 used in the position management system 700. The name 1132 represents the name of each RFID reader. The user 1133 corresponds to the operator 704 who uses the RFID reader 705, and is represented by the value of a user ID 1141 of the user table 1007.

The user table 1007 includes data items of the user ID 1141 and a name 1142. The user ID 1141 is identification information for uniquely identifying each of the operators 704. The name 1142 represents the name of each user. The user table 1007 may further include authentication information (for example, a password) used when the operator 704 logs in to the position management system 700, and the information of the user terminal 706. In other words, the RFID reader table 1006 is information for associating the RFID reader 705a with the user terminal 706.

The moving amount table 1008 is a table for accumulating, at each time, a record (to be referred to as a measurement result record hereinafter) of measurement result data received from the RFID reader 705. That is, the RFID reader 705 transmits the measurement result record to the management server 701 at a predetermined time interval or by a user operation. The moving amount table 1008 includes data items of a measurement time 1151, an RFID reader ID 1152, and a moving amount 1153. The measurement time 1151 represents the time at which measurement is performed with respect to a measurement result indicated by each measurement result record. The RFID reader ID 1152 is identification information for identifying the RFID reader 705 that has performed measurement with respect to the measurement result indicated by each measurement result record. The moving amount 1153 represents a relative moving amount as the measurement result. In this example, the moving amount 1153 represents a relative moving amount in the form of a two-dimensional vector in the coordinate system of the real space. For example, FIG. 11E shows the fact that the RFID reader 705a identified by RD01 moves with the lapse of time.

The tag detection table 1009 is a table for accumulating, at each time, a record (to be referred to as a reading result record hereinafter) of reading result data received from the RFID reader 705. That is, the RFID reader 705 transmits the reading result record to the management server 701 at a predetermined time interval or by a user operation. The tag detection table 1009 includes data items of a read time 1161, a tag ID 1162, an RFID reader ID 1163, a reception level 1164, and a detection position 1165. The read time 1161 represents the time at which the tag ID is read with respect to each reading result record. The tag ID 1162 represents a tag ID read with respect to each reading result record. The RFID reader ID 1163 is identification information for identifying the RFID reader 705 that has performed tag reading with respect to each reading result record. The reception level 1164 represents the reception level of the signal received by the RFID reader 705 at the time of tag reading with respect to each reading result record. The detection position 1165 represents the position coordinates (that is, the detection position of the article tag 709) of a point at which the RFID reader 705 exists when tag reading from the article tag 709 is performed. For example, the coordinates of the position tag 707 near the article tag 709 for which reading has been performed are transmitted as the detection position 1165. If there is no position tag 707 nearby at the time of transmission, “-” is transmitted as indicated by the detection position 1165 in the uppermost record in FIG. 11F.

As described above, in the position management system 700, it is possible to manage the position (work process place) of each article when the RFID reader provided in each work process place or the RFID reader worn by the operator reads the tag added to each article (for example, a work instruction document or a returnable container). In addition, since the RFID reader has a function of measuring the position of the self-device, even if, for example, the operator moves between the work process places while carrying the article, it is possible to manage, as the position of the article, the position of the RFID reader worn by the operator.

FIG. 12 is a view showing examples of the configurations of the process management system 1200 and the production management system 1210. Each of the process management system 1200 and the production management system 1210 may be configured as an information processing apparatus such as a PC. In this case, the information processing apparatus has the configuration shown in FIG. 2. The process management system 1200 and the production management system 1210 can communicate with the information processing apparatus 101 and the position management system 700 via the network. The network corresponds to the network described with reference to FIG. 1.

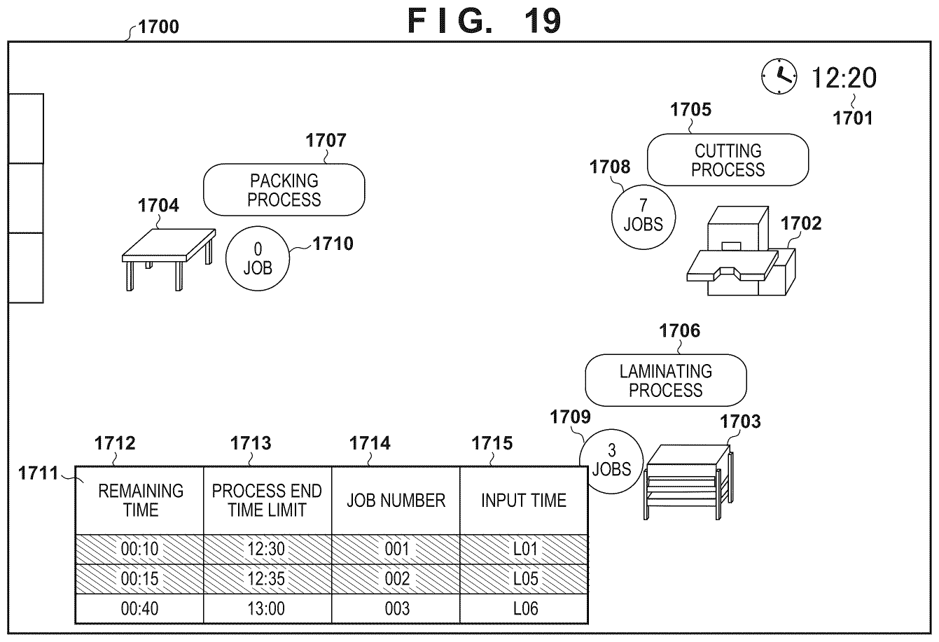

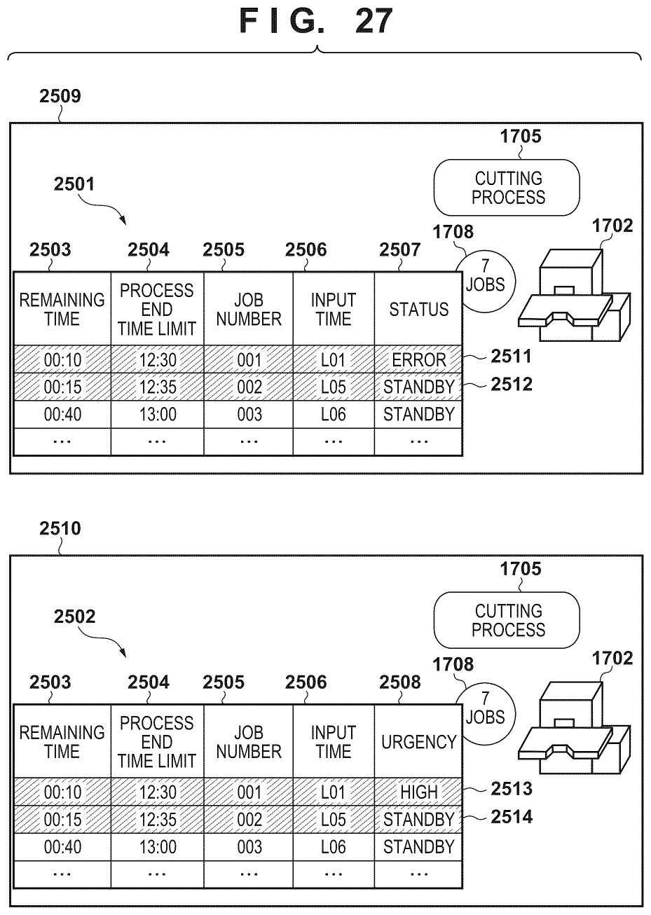

The process management system 1200 is a system that generates a process management screen in response to a process management screen request received from the Web browser of the information processing apparatus 101. The process management screen is a screen that displays the image forming apparatuses 102 in an area of a printing factory, the post-processing apparatuses 103, and information of processes performed by the respective post-processing apparatuses 103. The process management screen is, for example, a screen including information of FIGS. 19 and 27 to be described later. The process management system 1200 includes a process management UI 1201, a process management service 1202, a process database (DB) 1203, a job management service 1206, and a job database (DB) 1207. In addition, the process DB 1203 includes a job table 1204 and a process position table 1205, and the job DB 1207 includes a job status table 1208.

Upon receiving a process management screen request from the information processing apparatus 101, the process management UI 1201 generates a process management screen based on information collected by the process management service 1202, and transmits it to the information processing apparatus 101. In response to the request from the process management UI 1201, the process management service 1202 acquires information from the position management system 700, the job management service 1206, the process DB 1203, and a manufacturing process registration DB 1212 of the production management system 1210, and transmits it to the process management UI 1201. The process DB 1203 includes the job table 1204 and the process position table 1205.

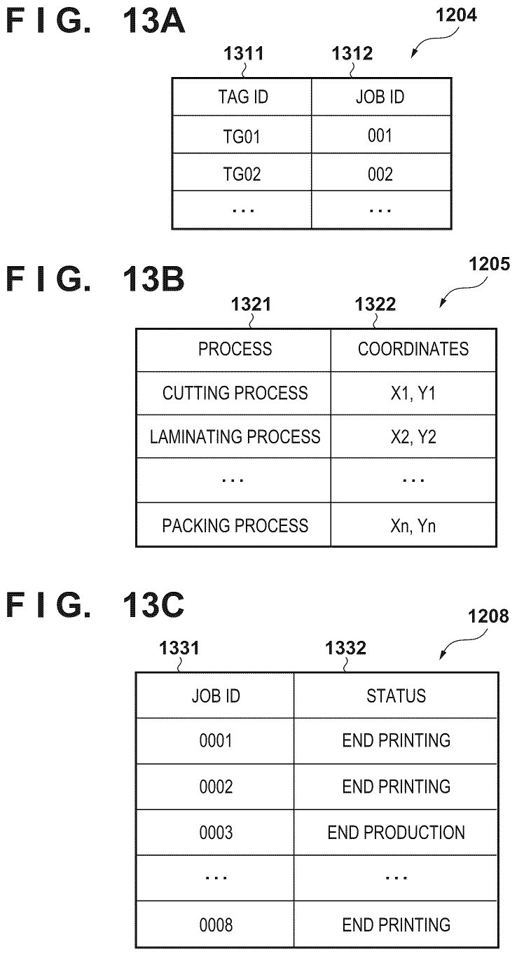

FIG. 13A is a table showing an example of the job table 1204. The job table 1204 is a table for managing the tag ID 710 of the article tag 709 added to the article 711 in FIG. 7 and the job ID of the job in linkage with each other. The job table 1204 includes items of a tag ID 1311 and a job ID 1312. The tag ID 710 and the job ID may be linked with each other by, for example, sequentially reading a barcode added to the article 711 such as a returnable container or a work instruction document and a barcode added to the job. The barcode added to the article 711 includes the same information as that of the tag ID. For example, a two-dimensional barcode printed in a region outside a print region on a sheet printed out can be read as a barcode added to the job. FIG. 13B is a table showing an example of the process position table 1205. The process position table 1205 is a table for managing each process 1321 corresponding to each work process place in the printing factory, and information of coordinates 1322 of each process. The process position table 1205 defines coordinate information in advance with respect to the location of each process in the printing factory.

The process management service 1202 acquires the tag ID 1111 and its coordinates 1116 from the article table 1004 in the management server 701 of the position management system 700. The tag ID 1111 and its coordinates 1116 are information of the tag ID detected by the RFID reader 705 for each process and the coordinates of the tag ID. Note that the RFID reader 705 for each process is represented as an RFID reader 705c, 705d, or 705e in FIG. 14. Based on the acquired coordinates 1116 of the tag ID and the information of the process position table 1205, the process management service 1202 specifies the process where the tag ID 1111 exists in the printing factory. As a method of specifying the process, for example, the distance between the coordinates in the process position table 1205 and the coordinates 1116 of the tag ID may be calculated, and if the distance is equal to or smaller than a threshold, it may be determined that the tag ID exists in the process. Alternatively, the coordinates 1322 in the process position table 1205 may be designated by a region like (X1, Y1) to (X11, Y11), and if the detected coordinates 1116 of the tag ID fall within the region, it may be determined that the tag ID exists in the process.

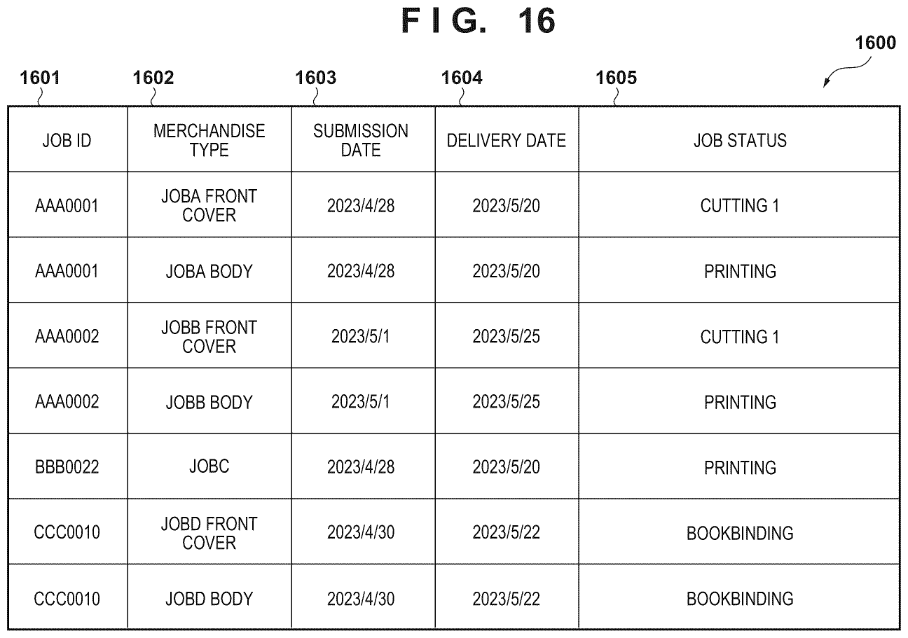

The job DB 1207 includes the job status table 1208. FIG. 13C is a table showing an example of the job status table 1208. The job status table 1208 is a table for managing a job ID 1331 and a job status 1332. The job status table 1208 is based on information of a job status of a production management screen 1600 shown in FIG. 16, which is acquired from the production management system 1210. In other words, the process management system 1200 shares, with the production management system 1210, the information of the production management screen 1600 managed by the production management system 1210. A job whose job status 1332 is “end of production” indicates that all the processes have been processed. A job whose job status 1332 is “end of printing” indicates that printing has ended and processing is being performed in an offline process. While a job processes each process indicated by the process 1321, “process in progress” is displayed as the job status 1332 for the process. When the process indicated by the process 1321 ends, “end of process” is displayed as the job status 1332 for the process. That is, when the job status 1605 of a job acquired from the production management system 1210 indicates the end of a given process, the process management system 1200 sets “end of process” for the process in the job status 1332 in the job status table 1208. For example, if the job status 1605 is “cutting 1”, the process management system 1200 manages that the laminating process as the preceding process has ended. Therefore, the process management system 1200 sets “end of process” for the laminating process in the job status 1332.

As described above, the process management system 1200 manages, based on the position information of each article tag managed by the position management system 700, the place of a specific process where each article is located. The process management system 1200 shares, with the production management system 1210, the information managed by the production management system 1210.

The production management system 1210 is a system that generates a production management screen in response to a production management screen request received from the Web browser of the information processing apparatus 101. The production management screen is a screen that displays the image forming apparatuses 102 in the printing factory, the post-processing apparatuses 103, and information of processes performed by the respective post-processing apparatuses 103. The production management screen is, for example, a screen shown in FIG. 16 to be described later. The production management system 1210 includes a production management UI 1211 and the manufacturing process registration DB 1212.

Upon receiving a production management screen request from the information processing apparatus 101, the production management UI 1211 generates a production management screen, and transmits it to the information processing apparatus 101.

FIG. 16 is a view showing an example of the production management screen displayed by the production management UI 1211 of the production management system 1210. The production management screen includes a job ID 1601, a merchandise type 1602, a submission date 1603, a delivery date 1604, and a job status 1605. In FIG. 16, an ordered job ID, an ordered merchandise type, a date/time when the order is submitted, the delivery date of the order, and the current job status of the order are displayed. When, for example, the operator ends a work in each work process place, the current job status of the order is updated based on information that is transmitted to the production management system 1210 by reading an end barcode provided in the place.

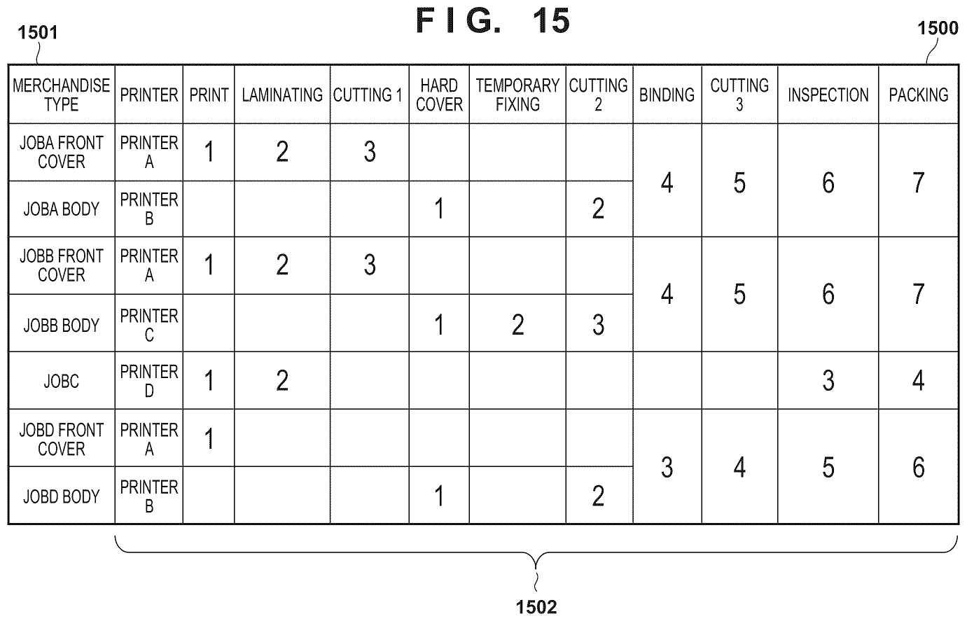

FIG. 15 is a table showing an example of manufacturing process registration information 1500 registered in advance in the manufacturing process registration DB 1212 in the production management system 1210 by a manager. The manufacturing process registration information 1500 includes a merchandise type 1501 and respective processes 1502. In this example, a printing process and post-printing bookbinding processes (to be referred to as post-processes hereinafter) are defined in advance. Since there are a plurality of printers, the name of each printer is described in the printing process. In the post-processes, processes of laminating, cutting 1, hard cover, temporary fixing, lay-flat, cutting 2, bookbinding, cutting 3, inspection, and packing are described. Since the order of the processes is decided for each merchandise, ordinal numbers are assigned to know the order of the processes in this example. In the bookbinding process of binding a front cover and the body, a work is performed after waiting for completion of the front cover and the body. If the post-processes are executed in an order other than the order defined in FIG. 15 by, for example, skipping a process or repeating the same process, an actually requested product is not completed. As an example, post-processes of JOBA will be described. In JOBA, a front cover and the body are separately manufactured, and are then bound in the bookbinding process to obtain a final product. The post-processes of the front cover of JOBA are performed in the order of laminating, cutting 1, and hard cover. The post-processes of the body of JOBA are performed in the order of temporary fixing and cutting 2. After waiting for completion of the hard cover process for the front cover of JOBA and a work of the cutting 2 process for the body, the process advances to the bookbinding process. After that, works are performed in the order of cutting 3, inspection, and packing. Note that in this case, an operator who performs the post-processes of the front cover, an operator who performs the post-processes of the body, and an operator who performs the post-processes after the bookbinding process may be different.

FIG. 14 is a view showing an example of the arrangement of the post-processes to be performed offline in an area 1400 in the printing factory. In this example, a cutting machine 1403, a laminating machine 1404, and a packing area 1405 are arranged as offline processes in the area 1400. The RFID readers 705c, 705d, and 705e for the cutting machine 1403, the laminating machine 1404, and the packing area 1405 are arranged near the respective processes, and standby areas 1402a, 1402b, and 1402c as the detectable ranges of the RFID readers 705c, 705d, and 705e are defined in advance.

Articles 711c, 711d, and 711e in FIG. 14 correspond to the article 711a in FIG. 7. Article tags 709c, 709d, and 709e in FIG. 14 correspond to the article tag 709a in FIG. 7. Tag IDs 710c, 710d, and 710e in FIG. 14 correspond to the tag ID 710a in FIG. 7. The RFID readers 705c, 705d, and 705e in FIG. 14 correspond to the RFID reader 705b in FIG. 7.

After finishing the work in each process, an operator 1406 stores the article 711b (work instruction document) and a product in the article 711a (returnable container) attached with the article tag 709, and arranges the article 711a in the standby area 1402 of the next process. This moves the article tag 709b between the processes together with the article 711a storing the article 711b. As an example of the article 711a, the tag ID is added to the returnable container, but the present invention is not limited to this. A tag ID may be added to a work instruction document or the like.

The RFID reader 705c, 705d, or 705e for each process detects each tag ID 710. Then, the position of each tag ID 710 is managed in the article table 1004 of the management server 701 of the position management system 700. By comparing the position information of each tag ID 710 with the process position table 1205, the process where each tag ID 710 exists is specified. Based on the information of the job table 1204, a job arranged in each process is specified.

In the production management system 1210, the manufacturing processes of each job are registered, as shown in FIG. 15, and the job status 1605 of each job shown in FIG. 16 is managed by an operation of reading the end barcode of the process work by the operator.

With respect to a “post-process” performed by an offline post-processing machine or the “packing process” as a work performed by a person, it is impossible to collect information via the network. Thus, it is impossible to manage and visualize a status such as a length of time during which a job stands by in each process and a specific process where a specific job exists. In this embodiment, it is possible to visualize and display a job that stands by in the post-processing machine in an offline state.

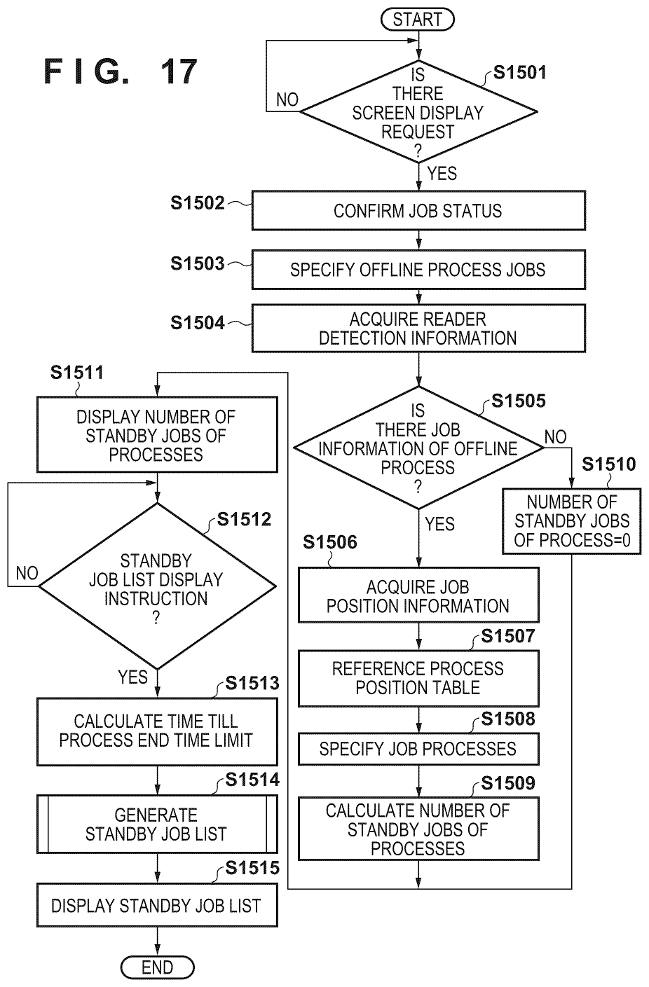

FIG. 17 is a flowchart illustrating processing of displaying the process management screen according to this embodiment. The processing shown in FIG. 17 is implemented when, for example, the CPU of the information processing apparatus forming the process management system 1200 reads out a program stored in the ROM and executes it.

In step S1501, the process management UI 1201 determines the presence/absence of a request to display the process management screen from the Web browser of the information processing apparatus 101. The processing of step S1501 is repeated until it is determined that a request to display the process management screen is present. If it is determined that a request to display the process management screen is present, the process advances to step S1502.

In step S1502, the process management UI 1201 refers to the job status table 1208. In step S1503, the process management UI 1201 specifies jobs in the offline processes. For example, the process management UI 1201 specifies, among jobs registered in the job status table 1208 referred to in step S1502, a job whose job status 1332 is “end of printing” but is not “end of production”. In step S1504, the process management UI 1201 acquires detection information by the tag reader 705 by acquiring information of the article DB 1001 from the position management system 700.

In step S1505, the process management UI 1201 determines whether jobs in the offline processes have been specified in step S1503. If it is determined that jobs in the offline processes have been specified, the process management UI 1201 acquires, in step S1506, pieces of position information of the jobs in the offline processes. With respect to the positions of the jobs in the offline processes, the process management UI 1201 first specifies the job IDs of the jobs in the offline processes based on the job status table 1208. Then, the process management UI 1201 specifies a tag ID corresponding to each job ID from the job table 1204. After that, the process management UI 1201 acquires the coordinates of the tag ID by acquiring the information of the article table 1004 from the position management system 700.

In step S1507, the process management UI 1201 refers to the process position table 1205. In step S1508, the process management UI 1201 specifies a process where each job is located. At this time, the process where each job is located specifies a process in the area 1400 of the printing factory, where the job exists, by referring to the process position table 1205 based on the position information of the job acquired in step S1506. As a method of specifying the process, for example, the distance between the coordinates in the process position table 1205 and the position information of each job may be calculated, and if the distance is equal to or smaller than a threshold, it may be determined that the job exists in the process. Alternatively, the coordinates 1322 in the process position table 1205 may be designated by a region like (X1, Y1) to (X11, Y11), and if the position information of each job falls within the region, it may be determined that the job exists in the process.

In step S1509, the process management UI 1201 calculates the number of standby jobs in each process. The number of standby jobs in each process is obtained by specifying the process in step S1508 for each of all the jobs in the offline processes specified in step S1503 and counting the number of jobs in each process. If it is determined in step S1505 that no jobs in the offline processes have been specified, the number of standby jobs in each process is set to “0” in step S1510, and the process advances to step S1511.

In step S1511, the process management UI 1201 displays the number of standby jobs in each process on the process management screen.

FIG. 19 is a view showing an example of a process management screen 1700. The process management screen 1700 is transmitted from the process management UI 1201 to the information processing apparatus 101 in response to a request from the information processing apparatus 101. The information processing apparatus 101 displays the process management screen 1700 by, for example, the Web browser. The numbers of standby jobs in the processes are displayed near, for example, pieces of information 1705, 1706, and 1707 respectively indicating the processes or images 1702, 1703, and 1704 respectively representing the processes in the process management screen 1700.

In step S1512, the process management UI 1201 determines the presence/absence of a standby job list display instruction. The standby job list display instruction may be, for example, the pressing of a number 1708, 1709, or 1710 of standby jobs in the process management screen 1700 by an input device such as a mouse or the pressing of the information 1705, 1706, or 1707 indicating the process on the process management screen 1700. The processing of step S1512 is repeated until it is determined that the standby job list display instruction is present.

If it is determined in step S1512 that the standby job list display instruction is present, the process management UI 1201 calculates, in step S1513, for each standby job in the process, a time until a work end time limit in the process. In other words, the work end time limit is a job execution time limit.

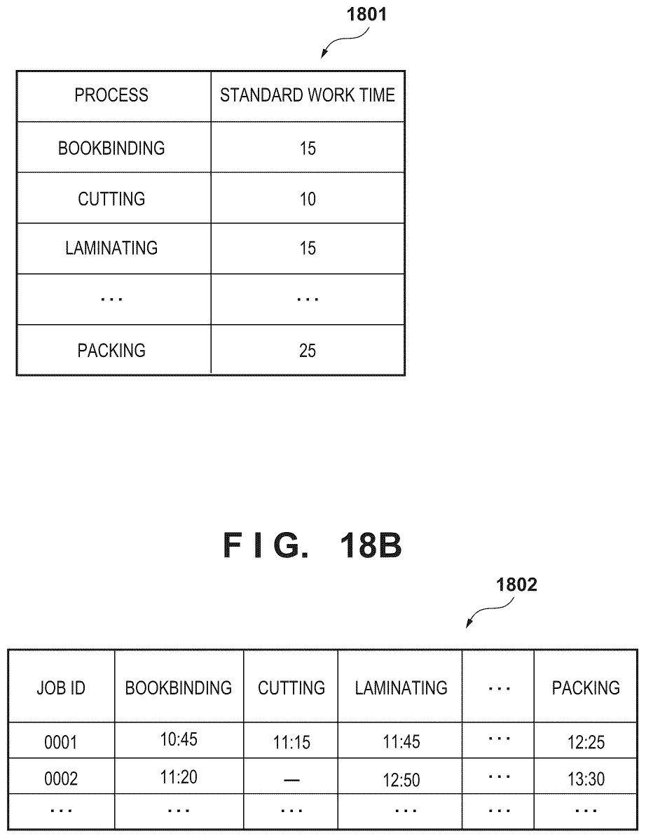

FIG. 18A is a table showing an example of a process standard work time table 1801 indicating a standard work time in each process. FIG. 18B is a table showing an example of a process work end time limit table 1802 indicating a work end time limit in each process. The process standard work time table 1801 and the process work end time limit table 1802 are managed in, for example, the print job information data 307 shown in FIG. 3. For example, the work end time limit of each process in the process work end time limit table 1802 is calculated based on the expected shipping date in the print job information table shown in FIG. 5, the process information in the merchandise information table shown in FIG. 6, and the information in the process standard work time table 1801 shown in FIG. 18A. The process management UI 1201 may request these pieces of information of the information processing apparatus 101 and acquire them.

In step S1513, for each of all the jobs existing in the process, the process management UI 1201 calculates the time until the work end time limit by comparing a current time 1701 with the work end time limit in the process where the job is located.

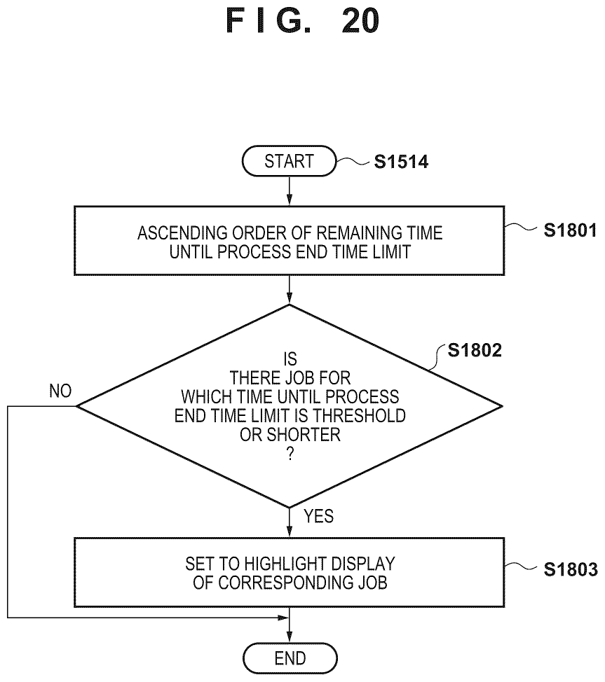

In step S1514, the process management UI 1201 generates the display order and display specification of a standby job list. The processing of step S1514 will be described later with reference to FIG. 20. In step S1515, the process management UI 1201 displays the standby job list based on the display order and display specification of the standby job list generated in step S1514. After that, the processing shown in FIG. 17 ends.

FIG. 20 is a flowchart illustrating the processing of generating the standby job list in step S1514. In step S1801, the process management UI 1201 sorts the standby jobs in the process in ascending order of remaining time until the work end time limit in the process. In step S1802, the process management UI 1201 determines the presence/absence of a job whose time until the work end time limit is equal to or shorter than a predetermined threshold. If it is determined that there is a job whose time until the work end time limit is equal to or shorter than the threshold, the process management UI 1201 sets, in step S1803, the corresponding job to be highlighted. The job need only to be highlighted to be identifiable from other jobs by, for example, changing color. After that, the processing shown in FIG. 20 ends. On the other hand, if it is determined that there is no job whose time until the work end time limit is equal to or shorter than the threshold, the processing shown in FIG. 20 ends.

A standby job list 1711 shown in FIG. 19 is an example of the standby job list created in FIG. 20. In the standby job list 1711, a remaining time 1712 until a work end time limit, a work end time limit 1713, a job number 1714, and an input time 1715 are displayed. However, the present invention is not limited to this. The standby job list 1711 may include another display item. In addition, in the standby job list 1711, jobs are displayed in ascending order of the remaining time 1712 until the work end time limit. If the remaining time 1712 until the work end time limit is shorter than the predetermined threshold, the corresponding job is highlighted.

As described above, in this embodiment, the positions of jobs in the offline processes are recognized based on the pieces of position information of the tag IDs managed by the position management system 700. Then, the number of jobs in each process is calculated and displayed. This configuration allows the user to recognize the number of jobs existing in each offline process and a list of the jobs. In addition, the remaining time until the work end time limit of each job in the process can be displayed, and the user can be made to recognize a job with a short remaining time by highlighting the job.

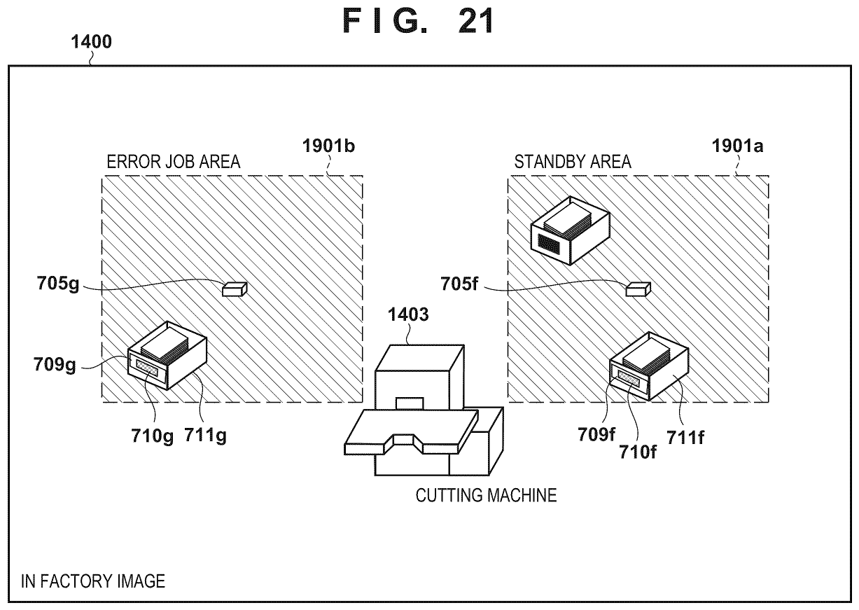

FIG. 21 is a view showing an example in which an error job area is provided near the offline process in the area 1400 of the printing factory, separately from a standby area. In this example, an area 1901a as a detectable range of a tag reader 705f and an area 1901b as a detectable range of a tag reader 705g are defined in advance near the cutting machine 1403.

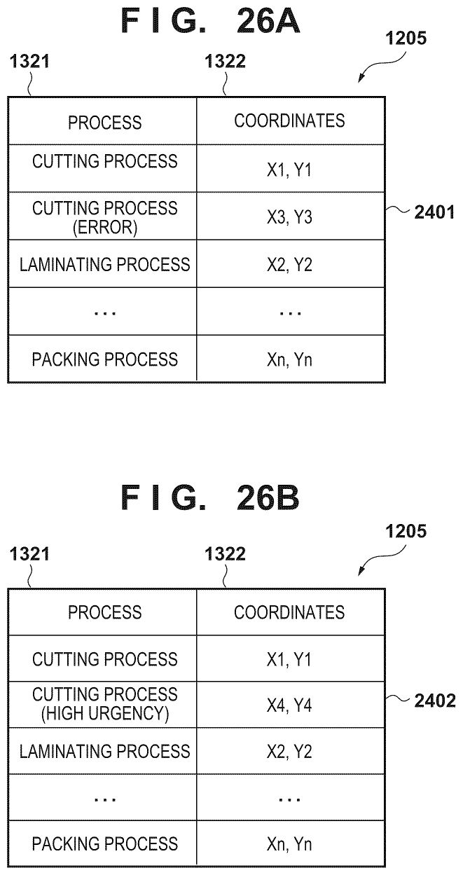

When performing processing by the cutting machine 1403 after the end of the work in the preceding process, the operator stores the job in the article 711 added with the article tag 709, and arranges it in the standby area 1901a. If an error occurs in the job during the work by the cutting machine 1403, the operator arranges the article 711 storing the job in the error state in the error job area 1901b. By detecting each tag ID 710 by the tag reader 705f or 705g for the standby area 1901a or the error job area 1901b, the position of each tag ID 710 is specified. FIG. 26A shows an example in which an error job area 2401 is added to the process 1321 of the process position table 1205. By comparing the specified position information of each tag ID 710 with the process position table 1205, the place of the process where each tag ID 710 is arranged is specified. Based on the information of the job table 1204, a job arranged in the place of each process is specified.

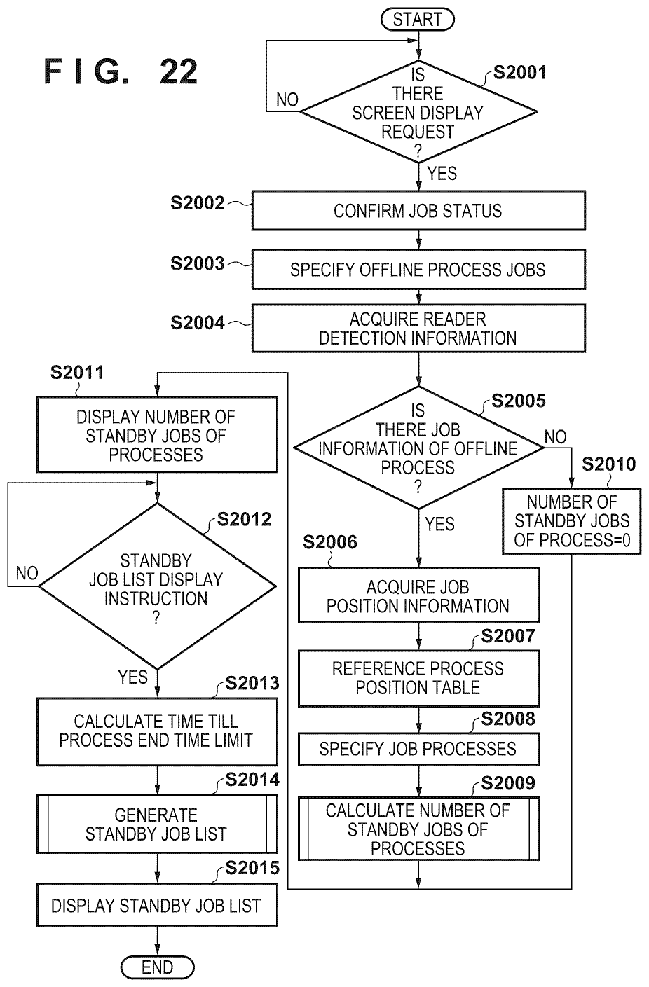

FIG. 22 is a flowchart illustrating processing of displaying the process management screen in a case where a region in which the article 711 is arranged is provided separately from the standby area. The processing shown in FIG. 22 is implemented when, for example, the CPU of the information processing apparatus forming the process management system 1200 reads out a program stored in the ROM and executes it.

Steps S2001 to S2008, S2010 to S2013, and S2015 are the same as steps S1501 to S1508, S1510 to S1513, and S1515 of FIG. 15 and a description thereof will be omitted.

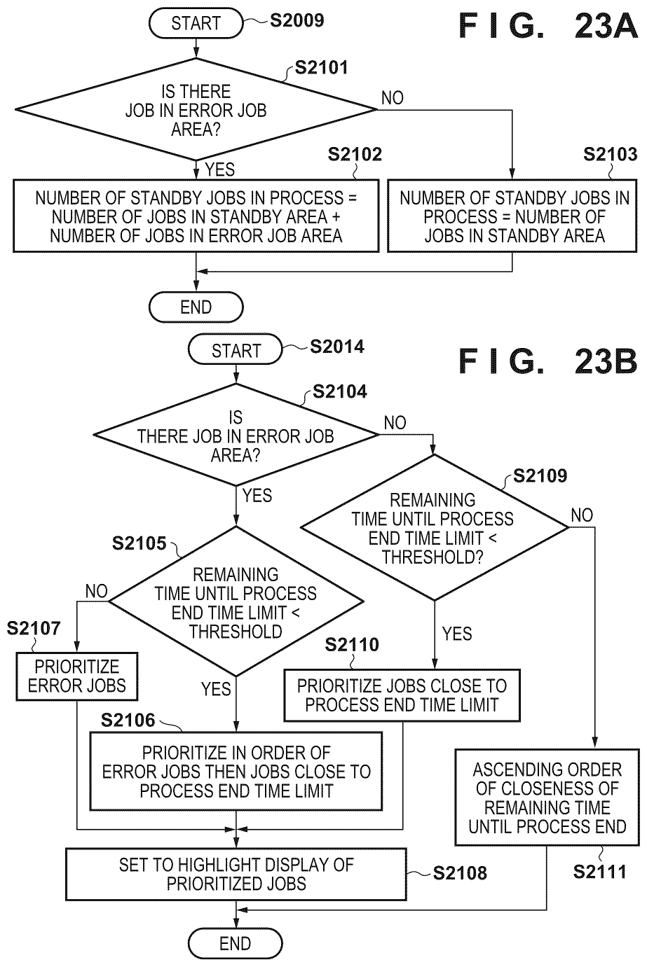

FIG. 23A is a flowchart illustrating processing of calculating the number of standby jobs in the process in step S2009. FIG. 23B is a flowchart illustrating processing of generating a standby job list in step S2014.

In step S2101 of FIG. 23A, based on information of a process where a job is arranged, which has been specified in step S2008, the process management UI 1201 determines whether there is a job arranged in the error job area 1901b. If it is determined that there is a job arranged in the error job area 1901b, the process management UI 1201 obtains, in step S2102, as the number of standby jobs in the process, the total value of the number of jobs arranged in the standby area 1901a and the number of jobs arranged in the error job area 1901b. After that, the processing shown in FIG. 23A ends. On the other hand, if it is determined in step S2101 that there is no job arranged in the error job area 1901b, the process management UI 1201 obtains, in step S2103, the number of jobs arranged in the standby area 1901a as the number of standby jobs in the process. After that, the processing shown in FIG. 23A ends.

In step S2104 of FIG. 23B, based on the information of the process where the job is arranged, which has been specified in step S2008, the process management UI 1201 determines whether there is a job arranged in the error job area 1901b. If it is determined that there is a job arranged in the error job area 1901b, the process management UI 1201 determines, in step S2105, whether there is a job whose time until the work end time limit calculated in step S2013 is equal to or shorter than the predetermined threshold. If it is determined that there is a job whose time until the work end time limit is equal to or shorter than the threshold, the process management UI 1201 sets, in step S2106, the display order of the standby job list to preferentially display an error job and a job close to the work end time limit in this order. The preferential display order may be expressed by, for example, a difference in display color. If it is determined in step S2105 that there is no job whose time until the work end time limit is equal to or shorter than the threshold, the process management UI 1201 sets, in step S2107, the display order of the standby job list to preferentially display an error job.

If it is determined in step S2104 that there is no job arranged in the error job area 1901b, the process management UI 1201 determines, in step S2109, whether there is a job whose time until the work end time limit calculated in step S2013 is equal to or shorter than the predetermined threshold. If it is determined that there is a job whose time until the work end time limit is equal to or shorter than the threshold, the process management UI 1201 sets, in step S2110, the display order of the standby job list to preferentially display a job close to the work end time limit. If it is determined in step S2109 that there is no job whose time until the work end time limit is equal to or shorter than the threshold, the process management UI 1201 sets, in step S2111, the display order of the standby job list to display the jobs in ascending order of the remaining time until the work end time limit, and then ends the processing of FIG. 23B. In step S2108, the process management UI 1201 sets to highlight the job set to be preferentially displayed in step S2106, S2107, or S2110, and then ends the processing of FIG. 23B.

Display 2509 shown in FIG. 27 is an example of display of the standby job list obtained by excerpting a portion near the cutting process 1705 on the process management screen 1700. Similar to the standby job list 1711, a standby job list 2501 shown in FIG. 27 includes a status 2507 in addition to a remaining time 2503 until a work end time limit, a work end time limit 2504, a job number 2505, and an input time 2506. In display 2511 of the status 2507, “standby” is displayed for a job arranged in the standby area 1901a. In display 2512, “error” is displayed for a job arranged in the error job area 1901b. The standby job list 2501 is displayed based on the display order and highlighting setting set in step S2014.

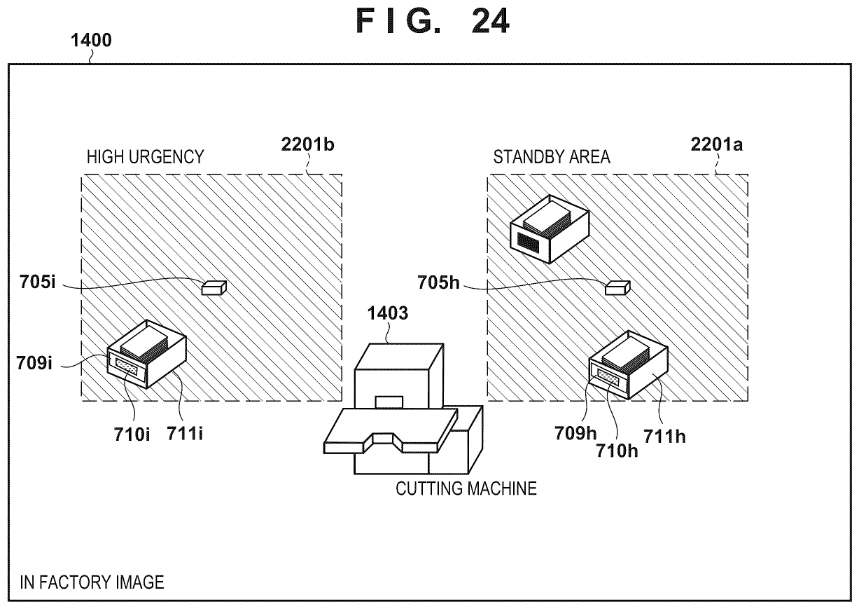

FIG. 24 is a view showing an example in which a region where a high urgency job is arranged is provided near the offline process in the area 1400 of the printing factory, separately from the standby area. In this example, an area 2201a as a detectable range of a tag reader 705h and an area 2201b as a detectable range of a tag reader 705i are defined in advance near the cutting machine 1403.

When performing processing by the cutting machine 1403 after the end of the work in the preceding process, the operator stores the job in the article 711 added with the article tag 709, and arranges it in the standby area 2201a. If, among the jobs to undergo the work by the cutting machine 1403, there is a job that needs to be urgently processed by raising the priority level, the article 711 storing the job is arranged in the high urgency area 2201b. By detecting each tag ID 710 by the tag reader 705h or 705i for the standby area 2201a or the high urgency area 2201b, the position of each tag ID 710 is specified. FIG. 26B shows an example in which a high urgency area 2402 is added to the process 1321 of the process position table 1205. By comparing the specified position information of each tag ID 710 with the process position table 1205, the place of the process where each tag ID 710 is arranged is specified. Based on the information of the job table 1204, a job arranged in the place of each process is specified.

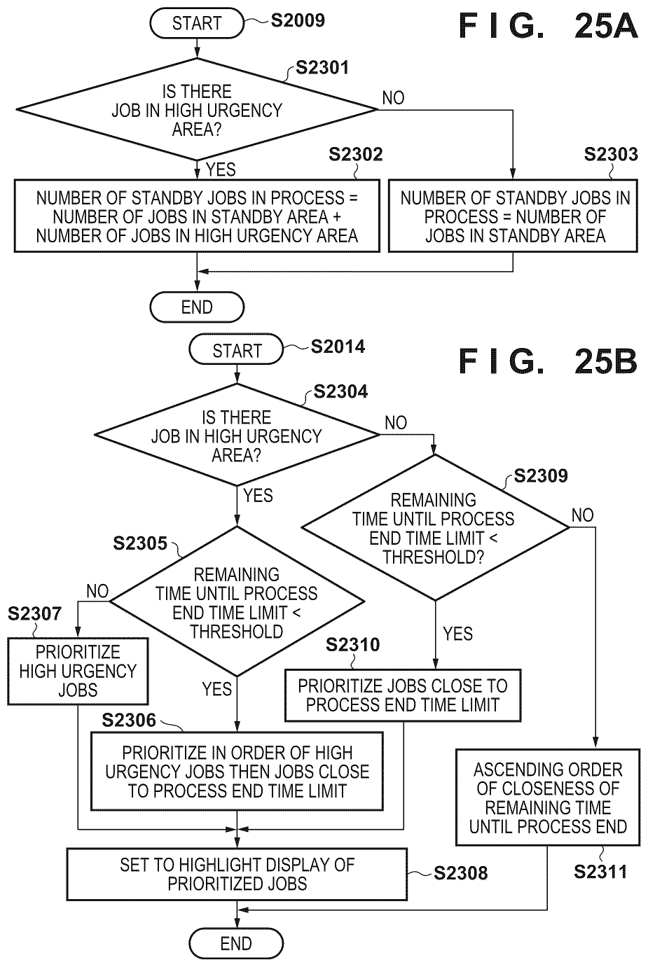

FIG. 25A is a flowchart illustrating processing of calculating the number of standby jobs in the process in step S2009 in a case where a region in which a high urgency job is arranged is provided separately from the standby area. FIG. 25B is a flowchart illustrating processing of generating a standby job list in step S2014.

In step S2301 of FIG. 25A, based on the information of the process where the job is arranged, which has been specified in step S2008, the process management UI 1201 determines whether there is a job arranged in the high urgency area 2201b. If it is determined that there is a job arranged in the high urgency area 2201b, the process management UI 1201 obtains, in step S2302, as the number of standby jobs in the process, the total value of the number of jobs arranged in the standby area 2201a and the number of jobs arranged in the high urgency area 2201b. After that, the processing shown in FIG. 25A ends. On the other hand, if it is determined in step S2301 that there is no job arranged in the high urgency area 2201b, the process management UI 1201 obtains, in step S2303, the number of jobs arranged in the standby area 2201a as the number of standby jobs in the process. After that, the processing shown in FIG. 25A ends.

In step S2304 of FIG. 25B, based on the information of the process where the job is arranged, which has been specified in step S2008, the process management UI 1201 determines whether there is a job arranged in the high urgency area 2201b. If it is determined that there is a job arranged in the high urgency area 2201b, the process management UI 1201 determines, in step S2305, whether there is a job whose time until the work end time limit calculated in step S2013 is equal to or shorter than the predetermined threshold. If it is determined that there is a job whose time until the work end time limit is equal to or shorter than the threshold, the process management UI 1201 sets, in step S2306, the display order of the standby job list to preferentially display a high urgency job and a job close to the work end time limit in this order. The preferential display order may be expressed by, for example, a difference in display color. If it is determined in step S2305 that there is no job whose time until the work end time limit is equal to or shorter than the threshold, the process management UI 1201 sets, in step S2307, the display order of the standby job list to preferentially display a high urgency job.

If it is determined in step S2304 that there is no job arranged in the high urgency area 2201b, the process management UI 1201 determines, in step S2309, whether there is a job whose time until the work end time limit calculated in step S2013 is equal to or shorter than the predetermined threshold. If it is determined that there is a job whose time until the work end time limit is equal to or shorter than the threshold, the process management UI 1201 sets, in step S2310, the display order of the standby job list to preferentially display a job close to the work end time limit. If it is determined in step S2309 that there is no job whose time until the work end time limit is equal to or shorter than the threshold, the process management UI 1201 sets, in step S2311, the display order of the standby job list to display the jobs in ascending order of the remaining time until the work end time limit, and then ends the processing of FIG. 25B. In step S2308, the process management UI 1201 sets to highlight the job set to be preferentially displayed in step S2306, S2307, or S2310, and then ends the processing of FIG. 25B.

Display 2510 shown in FIG. 27 is an example of display of the standby job list obtained by excerpting a portion near the cutting process 1705 on the process management screen 1700. Similar to the standby job list 1711, a standby job list 2502 shown in FIG. 27 includes urgency 2508 in addition to the remaining time 2503 until the work end time limit, the work end time limit 2504, the job number 2505, and the input time 2506. In display 2513 of the urgency 2508, “standby” is displayed for a job arranged in the standby area 2201a. In display 2514, “high” urgency is displayed for a job arranged in the high urgency area 2201b. The standby job list 2502 is displayed based on the display order and highlighting setting set in step S2014.

As described above, according to this embodiment, the user can be made to recognize the number of jobs in each offline process and a list of the jobs. Furthermore, it is possible to display the remaining time until the work end time limit of each job in the process, and the user can be made to recognize a job with a short remaining time by highlighting the job. In addition, it is possible to display a job to be able to identify whether the job is a high urgency job or a job in which an error has occurred in each process.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-138203, filed Aug. 28, 2023, which is hereby incorporated by reference herein in its entirety.

What is claimed is:

1. A method for a management system wherein a tag from which information can be read in a noncontact state is provided to be movable together with a product obtained by an apparatus corresponding to each process forming a workflow,
the method comprising:
detecting the tag arranged in association with the apparatus;
specifying, based on a result of the detection of the tag, a job located in each process forming the workflow; and
displaying information of the specified job in association with each process forming the workflow.

2. The method according to claim 1, wherein the detecting is performed in association with an apparatus corresponding to each of the plurality of processes forming the workflow.

3. The method according to claim 2, wherein
in the specifying, the number of jobs located in each of the plurality of processes is calculated based on the information of the detected tag, and
in the displaying, the number of jobs is displayed for each process forming the workflow.

4. The method according to claim 2, wherein in the displaying, a list of jobs located in each of the plurality of processes is displayed.

5. The method according to claim 4, wherein the list includes information representing a state of each job.

6. The method according to claim 5, further comprising detecting the tag associated with the apparatus and arranged together with a product in which an error has occurred,
wherein in the specifying, a job in an error state is specified based on the result of the detection of the tag, and
in the displaying, information of the specified job in the error state is displayed in association with the process forming the workflow.

7. The method according to claim 6, wherein in the list, the information of the job in the error state is preferentially displayed.

8. The method according to claim 4, wherein the list includes information representing urgency of each job.

9. The method according to claim 8, further comprising detecting the tag associated with the apparatus and arranged together with a high urgency product,
wherein in the specifying, a high urgency job is specified based on the result of the detection of the tag, and
in the displaying, information of the specified high urgency job is displayed in association with the process forming the workflow.

10. The method according to claim 9, wherein in the list, the high urgency job is preferentially displayed.

11. The method according to claim 4, wherein the list includes information of a job execution time limit.

12. The method according to claim 11, wherein in the list, a job whose remaining time until the execution time limit is shorter is more preferentially displayed.

13. The method according to claim 11, wherein in the list, a job whose remaining time until the execution time limit is shorter than a threshold is identifiably displayed.

14. The method according to claim 1, wherein the tag is added to a box capable of storing the product.

15. The method according to claim 1, wherein the tag is added to a medium indicating a procedure of the workflow.

16. The method according to claim 1, wherein the apparatus is a post-processing apparatus in an offline state.

17. The method according to claim 1, further comprising acquiring a reading result of code information printed on a printed material output from an image forming apparatus and a reading result of the information of the tag,
wherein a job of the workflow is associated with the tag based on the acquired reading result of the code information and the acquired reading result of the information of the tag.

18. The method according to claim 1, wherein the tag is a Radio Frequency Identification (RFID) tag.

19. A management system wherein a tag from which information can be read in a noncontact state is provided to be movable together with a product obtained by an apparatus corresponding to each process forming a workflow, and the system includes a detection unit configured to detect the tag arranged in association with the apparatus, the system comprising:
at least one processor and at least a memory coupled to the at least one processor and having instructions stored thereon, and when executed by the at least one processor, acting as:
a specifying unit configured to specify, based on a result of the detection of the tag by the detection unit, a job located in each process forming the workflow; and
a display unit configured to display information of the job specified by the specifying unit in association with each process forming the workflow.

20. A non-transitory computer-readable storage medium that stores one or more programs including instructions, which when executed by one or more processors of an information processing apparatus, cause the information processing apparatus to perform a control method, the control method comprising:
detecting a tag arranged in association with an apparatus;
specifying, based on a result of the detection of the tag, a job located in each process forming a workflow; and
displaying information of the specified job in association with each process forming the workflow.
